(19) United States
(12) Patent Application Publication
(10) Pub. No.: US 2017/0176192 A1
(43) Pub. Date: Jun. 22, 2017

(54) SYSTEMS AND METHODS TO EXTRAPOLATE HIGH-VALUE DATA FROM A NETWORK OF MOVING THINGS, FOR EXAMPLE INCLUDING A NETWORK OF AUTONOMOUS VEHICLES

(71) Applicant: Veniam, Inc., Mountain View, CA (US)

(72) Inventor: Daniel Cardoso de Moura, Gulpilhares (PT)

(21) Appl. No.: 15/351,811

(22) Filed: Nov. 15, 2016

Related U.S. Application Data
(60) Provisional application No. 62/270,678, filed on Dec. 22, 2015.

(51) Int. Cl. G01C 21/34; G05D 1/02; G01S 19/13; H04W 4/02; H04L 29/08

(52) U.S. Cl. CPC G01C 21/34; H04W 4/02; H04L 67/10; G01S 19/13; G05D 1/0278; H04W 84/005

(57) ABSTRACT

Communication network architectures, systems and methods for supporting a network of mobile nodes. As a non-limiting example, various aspects of this disclosure provide communication network architectures, systems, and methods supporting the collection of various kinds of data by mobile and fixed nodes and user devices operating in a geographic area, and the extrapolation from that data of information having significant value to various organizations operating in the geographic area.

### CROSS-REFERENCE TO RELATED APPLICATIONS/INCORPORATION BY REFERENCE

This patent application makes reference to, claims priority to, and claims benefit from U.S. Provisional Patent Application Ser. No. 62/270,678, filed on Dec. 22, 2015, and titled “Systems and Methods to Extrapolate High-Value Data from a Network of Moving Things,” which is hereby incorporated herein by reference in its entirety. The present application is also related to U.S. Provisional Application Ser. No. 62/221,997, titled “Integrated Communication Network for a Network of Moving Things,” filed on Sep. 22, 2015; U.S. Provisional Application Ser. No. 62/222,016, titled “Systems and Methods for Synchronizing a Network of Moving Things,” filed on Sep. 22, 2015; U.S. Provisional Application Ser. No. 62/222,042, titled “Systems and Methods for Managing a Network of Moving Things,” filed on Sep. 22, 2015; U.S. Provisional Application Ser. No. 62/222,066, titled “Systems and Methods for Monitoring a Network of Moving Things,” filed on Sep. 22, 2015; U.S. Provisional Application Ser. No. 62/222,077, titled “Systems and Methods for Detecting and Classifying Anomalies in a Network of Moving Things,” filed on Sep. 22, 2015; U.S. Provisional Application Ser. No. 62/222,098, titled “Systems and Methods for Managing Mobility in a Network of Moving Things,” filed on Sep. 22, 2015; U.S. Provisional Application Ser. No. 62/222,121, titled “Systems and Methods for Managing Connectivity a Network of Moving Things,” filed on Sep. 22, 2015; U.S. Provisional Application Ser. No. 62/222,135, titled “Systems and Methods for Collecting Sensor Data in a Network of Moving Things,” filed on Sep. 22, 2015; U.S. Provisional Application Ser. No. 62/222,145, titled “Systems and Methods for Interfacing with a Network of Moving Things,” filed on Sep. 22, 2015; U.S. Provisional Application Ser. No. 62/222,150, titled “Systems and Methods for Interfacing with a User of a Network of Moving Things,” filed on Sep. 22, 2015; U.S. Provisional Application Ser. No. 62/222,168, titled “Systems and Methods for Data Storage and Processing for a Network of Moving Things,” filed on Sep. 22, 2015; U.S. Provisional Application Ser. No. 62/222,183, titled “Systems and Methods for Vehicle Traffic Management in a Network of Moving Things,” filed on Sep. 22, 2015; U.S. Provisional Application Ser. No. 62/222,186, titled “Systems and Methods for Environmental Management in a Network of Moving Things,” filed on Sep. 22, 2015; U.S. Provisional Application Ser. No. 62/222,190, titled “Systems and Methods for Port Management in a Network of Moving Things,” filed on Sep. 22, 2015; U.S. Provisional Patent Application Ser. No. 62/222,192, titled “Communication Network of Moving Things,” filed on Sep. 22, 2015; U.S. Provisional Application Ser. No. 62/244,828, titled “Utilizing Historical Data to Correct GPS Data in a Network of Moving Things,” filed on Oct. 22, 2015; U.S. Provisional Application Ser. No. 62/244,930, titled “Using Anchors to Correct GPS Data in a Network of Moving Things,” filed on Oct. 22, 2015; U.S. Provisional Application Ser. No. 62/246,368, titled “Systems and Methods for Inter-Application Communication in a Network of Moving Things,” filed on Oct. 26, 2015; U.S. Provisional Application Ser. No. 62/246,372, titled “Systems and Methods for Probing and Validating Communication in a Network of Moving Things,” filed on Oct. 26, 2015; U.S. Provisional Application Ser. No. 62/250,544, titled “Adaptive Rate Control for Vehicular Networks,” filed on Nov. 4, 2015; U.S. Provisional Application Ser. No. 62/273,878, titled “Systems and Methods for Reconfiguring and Adapting Hardware in a Network of Moving Things,” filed on Dec. 31, 2015; U.S. Provisional Application Ser. No. 62/253,249, titled “Systems and Methods for Optimizing Data Gathering in a Network of Moving Things,” filed on Nov. 10, 2015; U.S. Provisional Application Ser. No. 62/257,421, titled “Systems and Methods for Delay Tolerant Networking in a Network of Moving Things,” filed on Nov. 19, 2015; U.S. Provisional Application Ser. No. 62/265,267, titled “Systems and Methods for Improving Coverage and Throughput of Mobile Access Points in a Network of Moving Things,” filed on Dec. 9, 2015; U.S. Provisional Application Ser. No. 62/270,858, titled “Channel Coordination in a Network of Moving Things,” filed on Dec. 22, 2015; U.S. Provisional Application Ser. No. 62/257,854, titled “Systems and Methods for Network Coded Mesh Networking in a Network of Moving Things,” filed on Nov. 20, 2015; U.S. Provisional Application Ser. No. 62/260,749, titled “Systems and Methods for Improving Fixed Access Point Coverage in a Network of Moving Things,” filed on Nov. 30, 2015; U.S. Provisional Application Ser. No. 62/273,715, titled “Systems and Methods for Managing Mobility Controllers and Their Network Interactions in a Network of Moving Things,” filed on Dec. 31, 2015; U.S. Provisional Application Ser. No. 62/281,432, titled “Systems and Methods for Managing and Triggering Handovers of Mobile Access Points in a Network of Moving Things,” filed on Jan. 21, 2016; U.S. Provisional Application Ser. No. 62/268,188, titled “Captive Portal-related Control and Management in a Network of Moving Things,” filed on Dec. 16, 2015; U.S. Provisional Application Ser. No. 62/270,678, titled “Systems and Methods to Extrapolate High-Value Data from a Network of Moving Things,” filed on Dec. 22, 2015; U.S. Provisional Application Ser. No. 62/272,750, titled “Systems and Methods for Remote Software Update and Distribution in a Network of Moving Things,” filed on Dec. 30, 2015; U.S. Provisional Application Ser. No. 62/278,662, titled “Systems and Methods for Remote Configuration Update and Distribution in a Network of Moving Things,” filed on Jan. 14, 2016; U.S. Provisional Application Ser. No. 62/286,243, titled “Systems and Methods for Adapting a Network of Moving Things Based on User Feedback,” filed on Jan. 22, 2016; U.S. Provisional Application Ser. No. 62/278,764, titled “Systems and Methods to Guarantee Data Integrity When Building Data Analytics in a Network of Moving Things,” Jan. 14, 2016; U.S. Provisional Application Ser. No. 62/286,515, titled “Systems and Methods for Self-Initialization and Automated Bootstrapping of Mobile Access Points in a Network of Moving Things,” filed on Jan. 25, 2016; U.S. Provisional Application Ser. No. 62/295,602, titled “Systems and Methods for Power Management in a Network of Moving Things,” filed on Feb. 16, 2016; and U.S. Provisional Application Ser. No. 62/299,269, titled “Systems and Methods for Automating and Easing the Installation and Setup of the Infrastructure Supporting a Network of Moving Things,” filed on Feb. 24, 2016; each of which is hereby incorporated herein by reference in its entirety for all purposes.

### BACKGROUND

Current communication networks are unable to adequately support communication environments involving mobile and static nodes. As a non-limiting example, current communication networks are unable to adequately support a network comprising a complex array of both moving and static nodes (e.g., the Internet of moving things). Limitations and disadvantages of conventional methods and systems will become apparent to one of skill in the art, through comparison of such approaches with some aspects of the present methods and systems set forth in the remainder of this disclosure with reference to the drawings.

### BRIEF DESCRIPTION OF SEVERAL VIEWS OF THE DRAWINGS

FIG. 1 shows a block diagram of a communication network, in accordance with various aspects of this disclosure.

FIG. 2 shows a block diagram of a communication network, in accordance with various aspects of this disclosure.

FIG. 3 shows a diagram of a metropolitan area network, in accordance with various aspects of this disclosure.

FIG. 4 shows a block diagram of a communication network, in accordance with various aspects of this disclosure.

FIGS. 5A-5C show a plurality of network configurations illustrating the flexibility and/or and resiliency of a communication network, in accordance with various aspects of this disclosure.

FIG. 6 shows a block diagram of an example communication network, in accordance with various aspects of the present disclosure.

FIG. 7 is a flowchart illustrating collecting and analyzing data via a network of moving things to characterize a metropolitan area, in accordance with various aspects of the present invention.

FIG. 8 is a flowchart illustrating collecting and analyzing data via a network of moving things to discover information about a transit system, in accordance with various aspects of the present invention.

FIG. 9 is a flowchart illustrating collecting and analyzing data via a network of moving things to discover the condition of metropolitan area infrastructure, in accordance with various aspects of the present invention.

FIG. 10 is a flowchart illustrating collecting and analyzing data via a network of moving things to characterize third party networks, in accordance with various aspects of the present invention.

FIG. 11 is a block diagram of an example on-board unit (OBU), in accordance with various aspects of the present disclosure.

### SUMMARY

Communication network architectures, systems and methods for supporting a network of mobile nodes. Various aspects provide communication network architectures, systems, and methods supporting the collection of various kinds of data by mobile and fixed nodes and user devices operating in a metropolitan area, and the extrapolation from that data of information having significant value to various organizations operating in the metropolitan area.

### DETAILED DESCRIPTION OF VARIOUS ASPECTS OF THE DISCLOSURE

As utilized herein the terms “circuits” and “circuitry” refer to physical electronic components (i.e., hardware) and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (i.e., hardware) and any software and/or firmware (“code”) that may configure the hardware, be executed by the hardware, and or otherwise be associated with the hardware.

As utilized herein, circuitry is “operable” to perform a function whenever the circuitry comprises the necessary hardware and code (if any is necessary) to perform the function, regardless of whether performance of the function is disabled, or not enabled (e.g., by a user-configurable setting, factory setting or trim, etc.).

As utilized herein, “and/or” means any one or more of the items in the list joined by “and/or”. As an example, “x and/or y” means any element of the three-element set {(x), (y), (x, y)}. That is, “x and/or y” means “one or both of x and y.” As another example, “x, y, and/or z” means any element of the seven-element set {(x), (y), (z), (x, y), (x, z), (y, z), (x, y, z)}. That is, “x, y, and/or x” means “one or more of x, y, and z.” As utilized herein, the terms “e.g.,” and “for example,” “exemplary,” and the like set off lists of one or more non-limiting examples, instances, or illustrations.

The terminology used herein is for the purpose of describing particular examples only and is not intended to be limiting of the disclosure. As used herein, the singular forms are intended to include the plural forms as well, unless the context clearly indicates otherwise. It will be further understood that the terms “comprises,” “includes,” “comprising,” “including,” “has,” “have,” “having,” and the like when used in this specification, specify the presence of stated features, integers, steps, operations, elements, and/or components, but do not preclude the presence or addition of one or more other features, integers, steps, operations, elements, components, and/or groups thereof.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the present disclosure. Similarly, various spatial terms, such as “upper,” “lower,” “side,” and the like, may be used in distinguishing one element from another element in a relative manner. It should be understood, however, that components may be oriented in different manners, for example an electronic device may be turned sideways so that its “top” surface is facing horizontally and its “side” surface is facing vertically, without departing from the teachings of the present disclosure.

With the proliferation of the mobile and/or static things (e.g., devices, machines, people, etc.) and logistics for such things to become connected to each other (e.g., in the contexts of smart logistics, transportation, environmental sensing, etc.), a platform that is for example always-on, robust, scalable and secure that is capable of providing connectivity, services and Internet access to such things (or objects), anywhere and anytime is desirable. Efficient power utilization within the various components of such system is also desirable.

Accordingly, various aspects of the present disclosure provide a fully-operable, always-on, responsive, robust, scalable, secure platform/system/architecture to provide connectivity, services and Internet access to all mobile things and/or static things (e.g., devices, machines, people, access points, end user devices, sensors, etc.) anywhere and anytime, while operating in an energy-efficient manner.

Various aspects of the present disclosure provide a platform that is flexibly configurable and adaptable to the various requirements, features, and needs of different environments, where each environment may be characterized by a respective level of mobility and density of mobile and/or static things, and the number and/or types of access to those things. Characteristics of various environments may, for example, include high mobility of nodes (e.g., causing contacts or connections to be volatile), high number of neighbors, high number of connected mobile users, mobile access points, availability of multiple networks and technologies (e.g., sometimes within a same area), etc. For example, the mode of operation of the platform may be flexibly adapted from environment to environment, based on each environment's respective requirements and needs, which may be different from other environments. Additionally for example, the platform may be flexibly optimized (e.g., at design/installation time and/or in real-time) for different purposes (e.g., to reduce the latency, increase throughput, reduce power consumption, load balance, increase reliability, make more robust with regard to failures or other disturbances, etc.), for example based on the content, service or data that the platform provides or handles within a particular environment.

In accordance with various aspects of the present disclosure, many control and management services (e.g., mobility, security, routing, etc.) are provided on top of the platform (e.g., directly, using control overlays, using containers, etc.), such services being compatible with the services currently deployed on top of the Internet or other communication network(s).

The communication network (or platform), in whole or in part, may for example be operated in public and/or private modes of operation, for example depending on the use case. The platform may, for example, operate in a public or private mode of operation, depending on the use-case (e.g., public Internet access, municipal environment sensing, fleet operation, etc.).

Additionally for example, in an implementation in which various network components are mobile, the transportation and/or signal control mechanisms may be adapted to serve the needs of the particular implementation. Also for example, wireless transmission power and/or rate may be adapted (e.g., to mitigate interference, to reduce power consumption, to extend the life of network components, etc.

Various example implementations of a platform, in accordance with various aspects of the present disclosure, are capable of connecting different subsystems, even when various other subsystems that may normally be utilized are unavailable. For example, the platform may comprise various built-in redundancies and fail-recovery mechanisms. For example, the platform may comprise a self-healing capability, self-configuration capability, self-adaptation capability, etc. The protocols and functions of the platform may, for example, be prepared to be autonomously and smoothly configured and adapted to the requirements and features of different environments characterized by different levels of mobility and density of things (or objects), the number/types of access to those things. For example, various aspects of the platform may gather context parameters that can influence any or all decisions. Such parameters may, for example, be derived locally, gathered from a neighborhood, fixed APs, the Cloud, etc. Various aspects of the platform may also, for example, ask for historical information to feed any of the decisions, where such information can be derived from historical data, from surveys, from simulators, etc. Various aspects of the platform may additionally, for example, probe or monitor decisions made throughout the network, for example to evaluate the network and/or the decisions themselves in real-time. Various aspects of the platform may further, for example, enforce the decisions in the network (e.g., after evaluating the probing results). Various aspects of the platform may, for example, establish thresholds to avoid any decision that is to be constantly or repeatedly performed without any significant advantage (e.g., technology change, certificate change, IP change, etc.). Various aspects of the platform may also, for example, learn locally (e.g., with the decisions performed) and dynamically update the decisions.

In addition to (or instead of) failure robustness, a platform may utilize multiple connections (or pathways) that exist between distinct sub-systems or elements within the same sub-system, to increase the robustness and/or load-balancing of the system.

The following discussion will present examples of the functionality performed by various example subsystems of the communication network. It should be understood that the example functionality discussed herein need not be performed by the particular example subsystem or by a single subsystem. For example, the subsystems present herein may interact with each other, and data or control services may be deployed either in a centralized way, or having their functionalities distributed among the different subsystems, for example leveraging the cooperation between the elements of each subsystem.

Various aspects of the present disclosure provide a communication network (e.g., a city-wide vehicular network, a shipping port-sized vehicular network, a campus-wide vehicular network, etc.) that utilizes vehicles (e.g., autonomous vehicles, automobiles, buses, trucks, boats, forklifts, etc.) as Wi-Fi hotspots. Note that Wi-Fi is generally used throughout this discussion as an example, but the scope of various aspects of this disclosure is not limited thereto. For example, other wireless LAN technologies, PAN technologies, MAN technologies, etc., may be utilized. Such utilization may, for example, provide cost-effective ways to gather substantial amounts of urban data, and provide for the efficient offloading of traffic from congested cellular networks (or other networks). In controlled areas (e.g., ports, harbors, etc.) with many vehicles, a communication network in accordance with various aspects of this disclosure may expand the wireless coverage of existing enterprise Wi-Fi networks, for example providing for real-time communication with vehicle drivers (e.g., human, computer-controlled, etc.) and other mobile employees without the need for SIM cards or cellular (or other network) data plans.

Vehicles may have many advantageous characteristics that make them useful as Wi-Fi (or general wireless) hotspots. For example, vehicles generally have at least one battery, vehicles are generally densely spread over the city at street level and/or they are able to establish many contacts with each other in a controlled space, and vehicles can communicate with 10× the range of normal Wi-Fi in the 5.9 GHz frequency band, reserved for intelligent transportation systems in the EU, the U.S., and elsewhere. Note that the scope of this disclosure is not limited to such 5.9 GHz wireless communication. Further, vehicles are able to effectively expand their coverage area into a swath over a period of time, enabling a single vehicle access point to interact with substantially more data sources over the period of time.

In accordance with various aspects of the present disclosure, an affordable multi-network on-board unit (OBU) is presented. Note that the OBU may also be referred to herein as a mobile access point, Mobile AP, MAP, etc. The OBU may, for example, comprise a plurality of networking interfaces (e.g., Wi-Fi, 802.11p, 4G, Bluetooth, UWB, etc.). The OBU may, for example, be readily installed in or on private and/or public vehicles (e.g., individual user vehicles, vehicles of private fleets, vehicles of public fleets, autonomous vehicles, etc.). The OBU may, for example, be installed in transportation fleets, waste management fleets, law enforcement fleets, emergency services, road maintenance fleets, taxi fleets, aircraft fleets, etc. The OBU may, for example, be installed in or on a vehicle or other structure with free mobility or relatively limited mobility. The OBU may also, for example, be carried by a person or service animal, mounted to a bicycle, mounted to a moving machine in general, mounted to a container, etc.

The OBUs may, for example, operate to connect passing vehicles to the wired infrastructure of one or more network providers, telecom operators, etc. In accordance with the architecture, hardware, and software functionality discussed herein, vehicles and fleets can be connected not just to the cellular networks (or other wide area or metropolitan area networks, etc.) and existing Wi-Fi hotspots spread over a city or a controlled space, but also to other vehicles (e.g., utilizing multi-hop communications to a wired infrastructure, single or multi-hop peer-to-peer vehicle communication, etc.). The vehicles and/or fleets may, for example, form an overall mesh of communication links, for example including the OBUs and also fixed Access Points (APs) connected to the wired infrastructure (e.g., a local infrastructure, etc.). Note that OBUs herein may also be referred to as “Mobile APs,” “mobile hotspots,” “MAPs,” etc. Also note that fixed access points may also be referred to herein as Road Side Units (RSUs), Fixed APs, FAPs, etc.

In an example implementation, the OBUs may communicate with the Fixed APs utilizing a relatively long-range protocol (e.g., 802.11p, etc.), and the Fixed APs may, in turn, be hard wired to the wired infrastructure (e.g., via cable, tethered optical link, etc.). Note that Fixed APs may also, or alternatively, be coupled to the infrastructure via wireless link (e.g., 802.11p, etc.). Additionally, clients or user devices may communicate with the OBUs using one or more relatively short-range protocols (e.g., Wi-Fi, Bluetooth, UWB, etc.). The OBUs, for example having a longer effective wireless communication range than typical Wi-Fi access points or other wireless LAN/PAN access points (e.g., at least for links such as those based on 802.11p, etc.), are capable of substantially greater coverage areas than typical Wi-Fi or other wireless LAN/PAN access points, and thus fewer OBUs are necessary to provide blanket coverage over a geographical area.

The OBU may, for example, comprise a robust vehicular networking module (e.g., a connection manager) which builds on long-range communication protocol capability (e.g., 802.11p, etc.). For example, in addition to comprising 802.11p (or other long-range protocol) capability to communicate with Fixed APs, vehicles, and other nodes in the network, the OBU may comprise a network interface (e.g., 802.11a/b/g/n, 802.11ac, 802.11af, any combination thereof, etc.) to provide wireless local area network (WLAN) connectivity to end user devices, sensors, fixed Wi-Fi access points, etc. For example, the OBU may operate to provide in-vehicle Wi-Fi Internet access to users in and/or around the vehicle (e.g., a bus, train car, taxi cab, public works vehicle, etc.). The OBU may further comprise one or more wireless backbone communication interfaces (e.g., cellular network interfaces, etc.). Though in various example scenarios, a cellular network interface (or other wireless backbone communication interface) might not be the preferred interface for various reasons (e.g., cost, power, bandwidth, etc.), the cellular network interface may be utilized to provide connectivity in geographical areas that are not presently supported by a Fixed AP, may be utilized to provide a fail-over communication link, may be utilized for emergency communications, may be utilized to subscribe to local infrastructure access, etc. The cellular network interface may also, for example, be utilized to allow the deployment of solutions that are dependent on the cellular network operators.

An OBU, in accordance with various aspects of the present disclosure, may for example comprise a smart connection manager that can select the best available wireless link(s) (e.g., Wi-Fi, 802.11p, cellular, vehicle mesh, etc.) with which to access the Internet. The OBU may also, for example, provide geo-location capabilities (e.g., GPS, etc.), motion detection sensors to determine if the vehicle is in motion, and a power control subsystem (e.g., to ensure that the OBU does not deplete the vehicle battery, etc.). The OBU may, for example, comprise any or all of the sensors (e.g., environmental sensors, etc.) discussed herein.

The OBU may also, for example, comprise a manager that manages machine-to-machine data acquisition and transfer (e.g., in a real-time or delay-tolerant fashion) to and from the cloud. For example, the OBU may log and/or communicate information of the vehicles.

The OBU may, for example, comprise a connection and/or routing manager that operates to perform routing of communications in a vehicle-to-vehicle/vehicle-to-infrastructure multi-hop communication. A mobility manager (or controller, MC) may, for example, ensure that communication sessions persist over one or more handoff(s) (also referred to herein as a “handover” or “handovers”) (e.g., between different Mobile APs, Fixed APs, base stations, hot spots, etc.), among different technologies (e.g., 802.11p, cellular, Wi-Fi, satellite, etc.), among different MCs (e.g., in a fail-over scenario, load redistribution scenario, etc.), across different interfaces (or ports), etc. Note that the MC may also be referred to herein as a Local Mobility Anchor (LMA), a Network Controller, etc. Note that the MC, or a plurality thereof, may for example be implemented as part of the backbone, but may also, or alternatively, be implemented as part of any of a variety of components or combinations thereof. For example, the MC may be implemented in a Fixed AP (or distributed system thereof), as part of an OBU (or a distributed system thereof), etc. Various non-limiting examples of system components and/or methods are provided in U.S. Provisional Application No. 62/222,098, filed Sep. 22, 2015, and titled “Systems and Method for Managing Mobility in a Network of Moving Things,” the entire contents of which are hereby incorporated herein by reference. Note that in an example implementation including a plurality of MCs, such MCs may be co-located and/or may be geographically distributed.

Various aspects of the present disclosure also provide a cloud-based service-oriented architecture that handles the real-time management, monitoring and reporting of the network and clients, the functionalities required for data storage, processing and management, the Wi-Fi client authentication and Captive Portal display, etc.

A communication network (or component thereof) in accordance with various aspects of the present disclosure may, for example, support a wide range of smart city applications (or controlled scenarios, or connected scenarios, etc.) and/or use-cases, as described herein.

For example, an example implementation may operate to turn each vehicle (e.g., both public and private taxis, buses, trucks, etc.) into a Mobile AP (e.g., a mobile Wi-Fi hotspot), offering Internet access to employees, passengers and mobile users travelling in the city, waiting in bus stops, sitting in parks, etc. Moreover, through an example vehicular mesh network formed between vehicles and/or fleets of vehicles, an implementation may be operable to offload cellular traffic through the mobile Wi-Fi hotspots and/or fixed APs (e.g., 802.11p-based APs) spread over the city and connected to the wired infrastructure of public or private telecom operators in strategic places, while ensuring the widest possible coverage at the lowest possible cost.

An example implementation (e.g., of a communication network and/or components thereof) may, for example, be operable as a massive urban scanner that gathers large amounts of data (e.g., continuously) on-the-move, actionable or not, generated by a myriad of sources spanning from the in-vehicle sensors or On Board Diagnostic System port (e.g., OBD2, etc.), external Wi-Fi/Bluetooth-enabled sensing units spread over the city, devices of vehicles' drivers and passengers (e.g., information characterizing such devices and/or passengers, etc.), positioning system devices (e.g., position information, velocity information, trajectory information, travel history information, etc.), etc.

Depending on the use case, the OBU may for example process (or computer, transform, manipulate, aggregate, summarize, etc.) the data before sending the data from the vehicle, for example providing the appropriate granularity (e.g., value resolution) and sampling rates (e.g., temporal resolution) for each individual application. For example, the OBU may, for example, process the data in any manner deemed advantageous by the system. The OBU may, for example, send the collected data (e.g., raw data, preprocessed data, information of metrics calculated based on the collected data, etc.) to the Cloud (e.g., to one or more networked servers coupled to any portion of the network) in an efficient and reliable manner to improve the efficiency, environmental impact and social value of municipal city operations and transportation services. Various example use cases are described herein.

In an example scenario in which public buses are moving along city routes and/or taxis are performing their private transportation services, the OBU is able to collect large quantities of real-time data from the positioning systems (e.g., GPS, etc.), from accelerometer modules, etc. The OBU may then, for example, communicate such data to the Cloud, where the data may be processed, reported and viewed, for example to support such public or private bus and/or taxi operations, for example supporting efficient remote monitoring and scheduling of buses and taxis, respectively.

In an example implementation, small cameras (or other sensors) may be coupled to small single-board computers (SBCs) that are placed above the doors of public buses to allow capturing image sequences of people entering and leaving buses, and/or on stops along the bus routes in order to estimate the number of people waiting for a bus. Such data may be gathered by the OBU in order to be sent to the Cloud. With such data, public transportation systems may detect peaks; overcrowded buses, routes and stops; underutilized buses, routes and stops; etc., enabling action to be taken in real-time (e.g., reducing bus periodicity to decrease fuel costs and CO₂ emissions where and when passenger flows are smaller, etc.) as well as detecting systematic transportation problems.

An OBU may, for example, be operable to communicate with any of a variety of Wi-Fi-enabled sensor devices equipped with a heterogeneous collection of environmental sensors. Such sensors may, for example, comprise noise sensors (microphones, etc.), gas sensors (e.g., sensing CO, NO₂, O₃, volatile organic compounds (or VOCs), CO₂, etc.), smoke sensors, pollution sensors, meteorological sensors (e.g., sensing temperature, humidity, luminosity, particles, solar radiation, wind speed (e.g., anemometer), wind direction, rain (e.g., a pluviometer), optical scanners, biometric scanners, cameras, microphones, etc.). Such sensors may also comprise sensors associated with users (e.g., vehicle operators or passengers, passersby, etc.) and/or their personal devices (e.g., smart phones or watches, biometrics sensors, wearable sensors, implanted sensors, etc.). Such sensors may, for example, comprise sensors and/or systems associated with on-board diagnostic (OBD) units for vehicles. Such sensors may, for example, comprise positioning sensors (e.g., GPS sensors, Galileo sensors, GLONASS sensors, etc.). Such sensors may, for example, comprise container sensors (e.g., garbage can sensors, shipping container sensors, container environmental sensors, container tracking sensors, etc.).

Once a vehicle enters the vicinity of such a sensor device, a wireless link may be established, so that the vehicle (or OBU thereof) can collect sensor data from the sensor device and upload the collected data to a database in the Cloud. The appropriate action can then be taken. In an example waste management implementation, several waste management (or collection) trucks may be equipped with OBUs that are able to periodically communicate with sensors installed on containers in order to gather information about waste level, time passed since last collection, etc. Such information may then sent to the Cloud (e.g., to a waste management application coupled to the Internet, etc.) through the vehicular mesh network, in order to improve the scheduling and/or routing of waste management trucks. Note that various sensors may always be in range of the Mobile AP (e.g., vehicle-mounted sensors). Note that the sensor may also (or alternatively) be mobile (e.g., a sensor mounted to another vehicle passing by a Mobile AP or Fixed AP, a drone-mounted sensor, a pedestrian-mounted sensor, etc.).

In an example implementation, for example in a controlled space (e.g., a port, harbor, airport, factory, plantation, mine, etc.) with many vehicles, machines and employees, a communication network in accordance with various aspects of the present disclosure may expand the wireless coverage of enterprise and/or local Wi-Fi networks, for example without resorting to a Telco-dependent solution based on SIM cards or cellular fees. In such an example scenario, apart from avoiding expensive cellular data plans, limited data rate and poor cellular coverage in some places, a communication network in accordance with various aspects of the present disclosure is also able to collect and/or communicate large amounts of data, in a reliable and real-time manner, where such data may be used to optimize harbor logistics, transportation operations, etc.

For example in a port and/or harbor implementation, by gathering real-time information on the position, speed, fuel consumption and CO₂ emissions of the vehicles, the communication network allows a port operator to improve the coordination of the ship loading processes and increase the throughput of the harbor. Also for example, the communication network enables remote monitoring of drivers' behaviors, trucks' positions and engines' status, and then be able to provide real-time notifications to drivers (e.g., to turn on/off the engine, follow the right route inside the harbor, take a break, etc.), thus reducing the number and duration of the harbor services and trips. Harbor authorities may, for example, quickly detect malfunctioning trucks and abnormal trucks' circulation, thus avoiding accidents in order to increase harbor efficiency, security, and safety. Additionally, the vehicles can also connect to Wi-Fi access points from harbor local operators, and provide Wi-Fi Internet access to vehicles' occupants and surrounding harbor employees, for example allowing pilots to save time by filing reports via the Internet while still on the water.

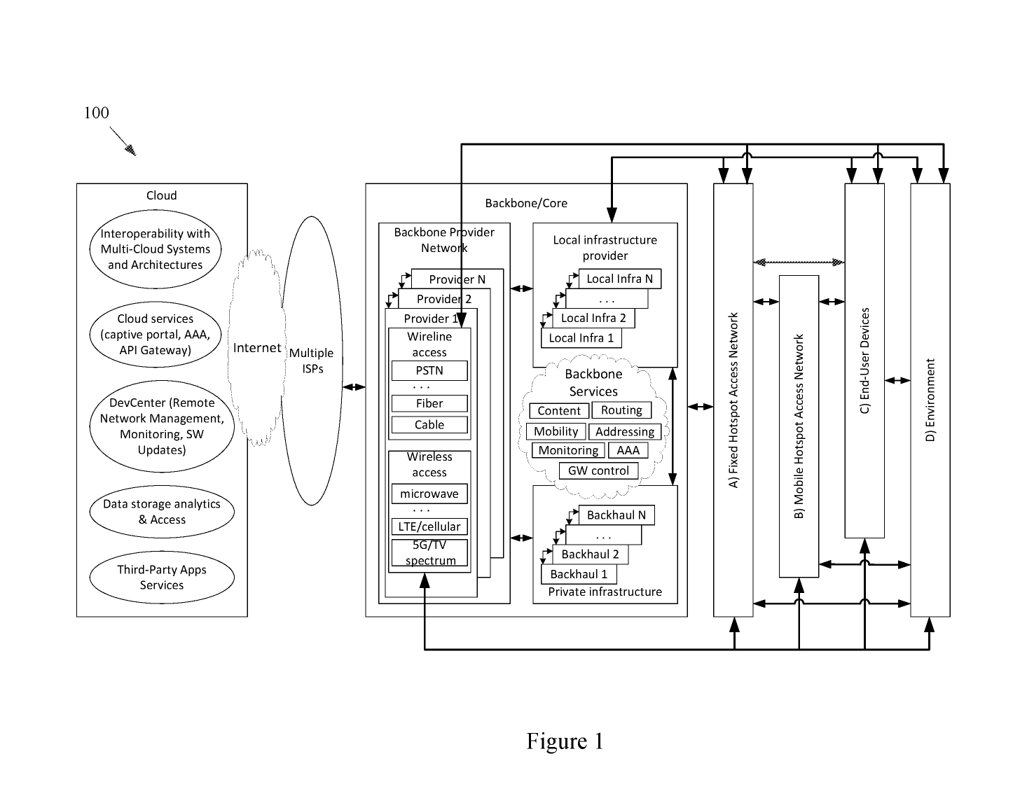

FIG. 1 shows a block diagram of a communication network 100, in accordance with various aspects of this disclosure. Any or all of the functionality discussed herein may be performed by any or all of the example components of the example network 100. Also, the example network 100 may, for example, share any or all characteristics with the other example networks and/or network components 200, 300, 400, 500-570, and 600, discussed herein.

The example network 100, for example, comprises a Cloud that may, for example comprise any of a variety of network level components. The Cloud may, for example, comprise any of a variety of server systems executing applications that monitor and/or control components of the network 100. Such applications may also, for example, manage the collection of information from any of a large array of networked information sources, many examples of which are discussed herein. The Cloud (or a portion thereof) may also be referred to, at times, as an API. For example, Cloud (or a portion thereof) may provide one or more application programming interfaces (APIs) which other devices may use for communicating/interacting with the Cloud.

An example component of the Cloud may, for example, manage interoperability with various multi-cloud systems and architectures. Another example component (e.g., a Cloud service component) may, for example, provide various cloud services (e.g., captive portal services, authentication, authorization, and accounting (AAA) services, API Gateway services, etc.). An additional example component (e.g., a DevCenter component) may, for example, provide network monitoring and/or management functionality, manage the implementation of software updates, etc. A further example component of the Cloud may manage data storage, data analytics, data access, etc. A still further example component of the Cloud may include any of a variety of third-partly applications and services.

The Cloud may, for example, be coupled to the Backbone/Core Infrastructure of the example network 100 via the Internet (e.g., utilizing one or more Internet Service Providers). Though the Internet is provided by example, it should be understood that scope of the present disclosure is not limited thereto.

The Backbone/Core may, for example, comprise any one or more different communication infrastructure components. For example, one or more providers may provide backbone networks or various components thereof. As shown in the example network 100 illustrated in FIG. 1, a Backbone provider may provide wireline access (e.g., PSTN, fiber, cable, etc.). Also for example, a Backbone provider may provide wireless access (e.g., Microwave, LTE/Cellular, 5G/TV Spectrum, etc.).

The Backbone/Core may also, for example, comprise one or more Local Infrastructure Providers. The Backbone/Core may also, for example, comprise a private infrastructure (e.g., run by the network 100 implementer, owner, etc.). The Backbone/Core may, for example, provide any of a variety of Backbone Services (e.g., AAA, Mobility, Monitoring, Addressing, Routing, Content services, Gateway Control services, etc.).

The Backbone/Core Infrastructure may comprise any of a variety of characteristics, non-limiting examples of which are provided herein. For example, the Backbone/Core may be compatible with different wireless or wired technologies for backbone access. The Backbone/Core may also be adaptable to handle public (e.g., municipal, city, campus, etc.) and/or private (e.g., ports, campus, etc.) network infrastructures owned by different local providers, and/or owned by the network implementer or stakeholder. The Backbone/Core may, for example, comprise and/or interface with different Authentication, Authorization, and Accounting (AAA) mechanisms.

The Backbone/Core Infrastructure may, for example, support different modes of operation (e.g., L2 in port implementations, L3 in on-land public transportation implementations, utilizing any one or more of a plurality of different layers of digital IP networking, any combinations thereof, equivalents thereof, etc.) or addressing pools. The Backbone/Core may also for example, be agnostic to the Cloud provider(s) and/or Internet Service Provider(s). Additionally for example, the Backbone/Core may be agnostic to requests coming from any or all subsystems of the network 100 (e.g., Mobile APs or OBUs (On Board Units), Fixed APs or RSUs (Road Side Units), MCs (Mobility Controllers) or LMAs (Local Mobility Anchors) or Network Controllers, etc.) and/or third-party systems.

The Backbone/Core Infrastructure may, for example, comprise the ability to utilize and/or interface with different data storage/processing systems (e.g., MongoDB, MySql, Redis, etc.). The Backbone/Core Infrastructure may further, for example, provide different levels of simultaneous access to the infrastructure, services, data, etc.

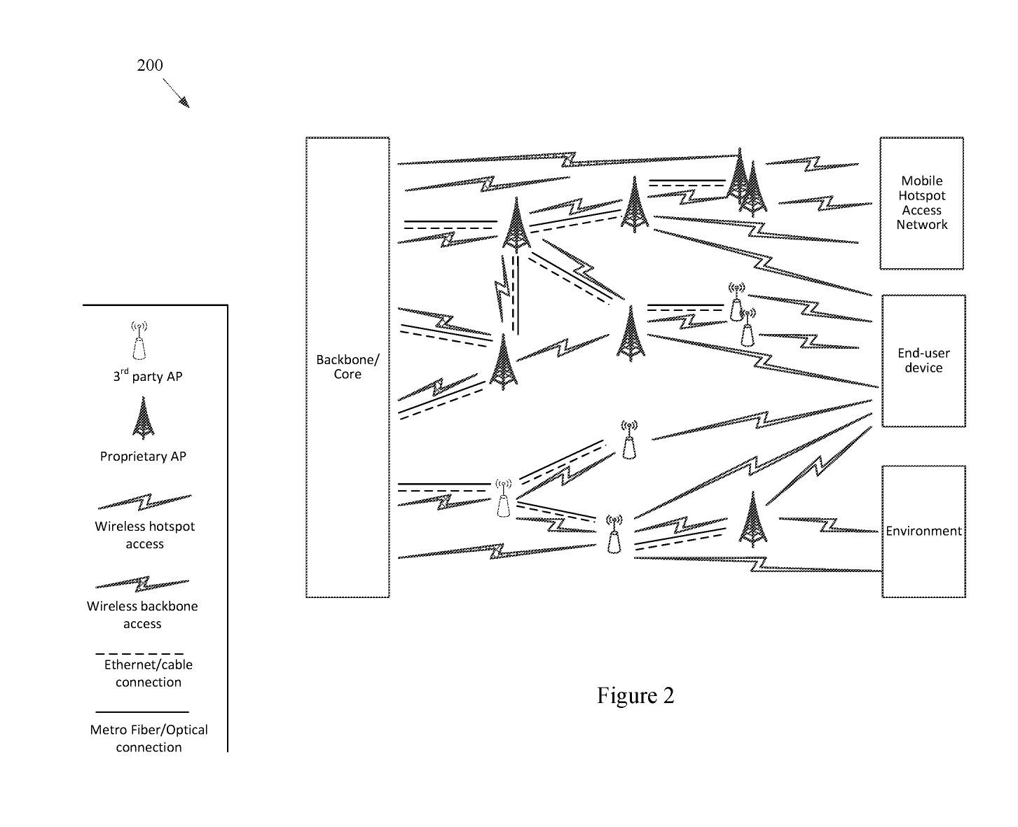

The example network 100 may also, for example, comprise a Fixed Hotspot Access Network. Various example characteristics of such a Fixed Hotspot Access Network 200 are shown at FIG. 2. The example network 200 may, for example, share any or all characteristics with the other example networks and/or network components 100, 300, 400, 500-570, and 600, discussed herein.

In the example network 200, the Fixed APs (e.g., the proprietary APs, the public third party APs, the private third party APs, etc.) may be directly connected to the local infrastructure provider and/or to the wireline/wireless backbone. Also for example, the example network 200 may comprise a mesh between the various APs via wireless technologies. Note, however, that various wired technologies may also be utilized depending on the implementation. As shown, different fixed hotspot access networks can be connected to a same backbone provider, but may also be connected to different respective backbone providers. In an example implementation utilizing wireless technology for backbone access, such an implementation may be relatively fault tolerant. For example, a Fixed AP may utilize wireless communications to the backbone network (e.g., cellular, 3G, LTE, other wide or metropolitan area networks, etc.) if the backhaul infrastructure is down. Also for example, such an implementation may provide for relatively easy installation (e.g., a Fixed AP with no cable power source that can be placed virtually anywhere).

In the example network 200, the same Fixed AP can simultaneously provide access to multiple Fixed APs, Mobile APs (e.g., vehicle OBUs, etc.), devices, user devices, sensors, things, etc. For example, a plurality of mobile hotspot access networks (e.g., OBU-based networks, etc.) may utilize the same Fixed AP. Also for example, the same Fixed AP can provide a plurality of simultaneous accesses to another single unit (e.g., another Fixed AP, Mobile AP, device, etc.), for example utilizing different channels, different radios, etc.).

Note that a plurality of Fixed APs may be utilized for fault-tolerance/fail-recovery purposes. In an example implementation, a Fixed AP and its fail-over AP may both be normally operational (e.g., in a same switch). Also for example, one or more Fixed APs may be placed in the network at various locations in an inactive or monitoring mode, and ready to become operational when needed (e.g., in response to a fault, in response to an emergency services need, in response to a data surge, etc.).

Referring back to FIG. 1, the example Fixed Hotspot Access Network is shown with a wireless communication link to a backbone provider (e.g., to one or more Backbone Providers and/or Local Infrastructure Providers), to a Mobile Hotspot Access Network, to one or more End User Devices, and to the Environment. Also, the example Fixed Hotspot Access Network is shown with a wired communication link to one or more Backbone Providers, to the Mobile Hotspot Access Network, to one or more End User Devices, and to the Environment. The Environment may comprise any of a variety of devices (e.g., in-vehicle networks, devices, and sensors; autonomous vehicle networks, devices, and sensors; maritime (or watercraft) and port networks, devices, and sensors; general controlled-space networks, devices, and sensors; residential networks, devices, and sensors; disaster recovery & emergency networks, devices, and sensors; military and aircraft networks, devices, and sensors; smart city networks, devices, and sensors; event (or venue) networks, devices, and sensors; underwater and underground networks, devices, and sensors; agricultural networks, devices, and sensors; tunnel (auto, subway, train, etc.) networks, devices, and sensors; parking networks, devices, and sensors; security and surveillance networks, devices, and sensors; shipping equipment and container networks, devices, and sensors; environmental control or monitoring networks, devices, and sensors; municipal networks, devices, and sensors; waste management networks, devices, and sensors, road maintenance networks, devices, and sensors, traffic management networks, devices, and sensors; advertising networks, devices and sensors; etc.).

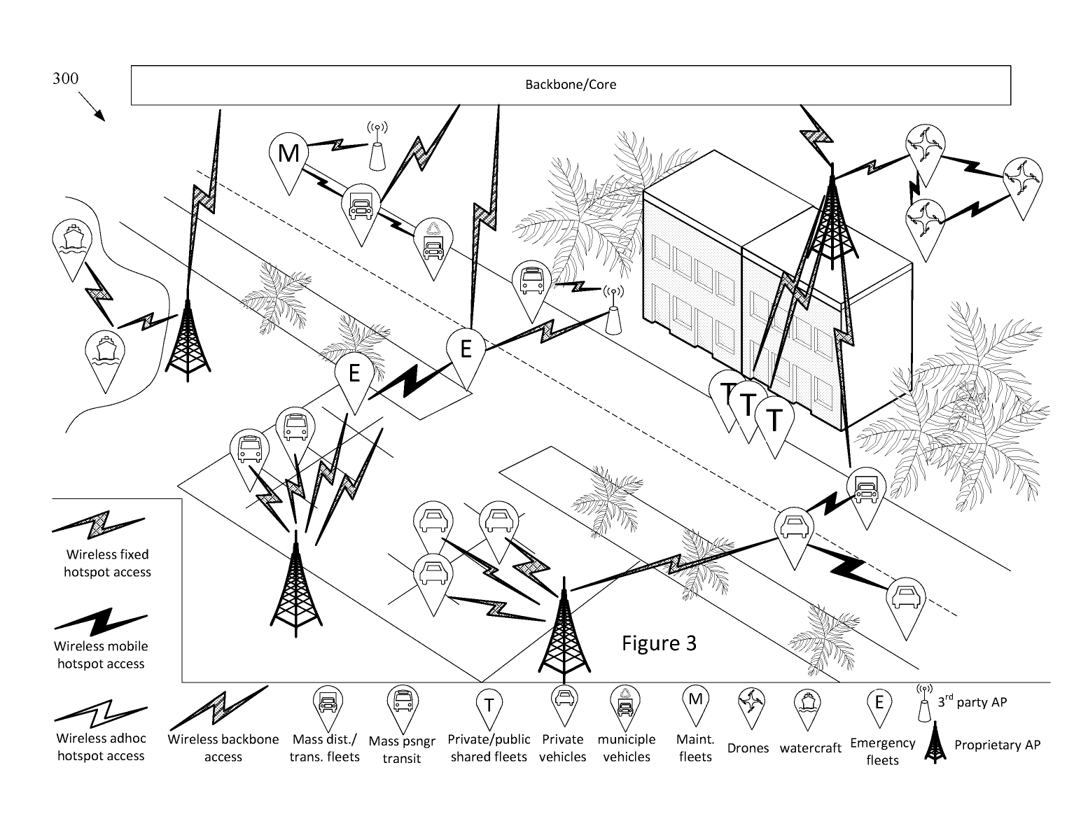

The example network 100 of FIG. 1 also comprises a Mobile Hotspot Access Network. Various example characteristics of such a Mobile Hotspot Access Network 300 are shown at FIG. 3. Note that various fixed network components (e.g., Fixed APs) are also illustrated. The example network 300 may, for example, share any or all characteristics with the other example networks and/or network components 100, 200, 400, 500-570, and 600 discussed herein.

The example network 300 comprises a wide variety of Mobile APs (or hotspots) that provide access to user devices, provide for sensor data collection, provide multi-hop connectivity to other Mobile APs, etc. For example, the example network 300 comprises vehicles from different fleets (e.g., aerial, terrestrial, underground, (under)water, etc.). For example, the example network 300 comprises one or more mass distribution/transportation fleets, one or more mass passenger transportation fleets, private/public shared-user fleets, private vehicles, urban and municipal fleets, maintenance fleets, drones, watercraft (e.g., boats, ships, speedboats, tugboats, barges, etc.), emergency fleets (e.g., police, ambulance, firefighter, etc.), etc.

The example network 300, for example, shows vehicles from different fleets directly connected and/or mesh connected, for example using same or different communication technologies. The example network 300 also shows fleets simultaneously connected to different Fixed APs, which may or may not belong to different respective local infrastructure providers. As a fault-tolerance mechanism, the example network 300 may for example comprise the utilization of long-range wireless communication network (e.g., cellular, 3G, 4G, LTE, etc.) in vehicles if the local network infrastructure is down or otherwise unavailable. A same vehicle (e.g., Mobile AP or OBU) can simultaneously provide access to multiple vehicles, devices, things, etc., for example using a same communication technology (e.g., shared channels and/or different respective channels thereof) and/or using a different respective communication technology for each. Also for example, a same vehicle can provide multiple accesses to another vehicle, device, thing, etc., for example using a same communication technology (e.g., shared channels and/or different respective channels thereof, and/or using a different communication technology).

Additionally, multiple network elements may be connected together to provide for fault-tolerance or fail recovery, increased throughput, or to achieve any or a variety of a client's networking needs, many of examples of which are provided herein. For example, two Mobile APs (or OBUs) may be installed in a same vehicle, etc.

Referring back to FIG. 1, the example Mobile Hotspot Access Network is shown with a wireless communication link to a backbone provider (e.g., to one or more Backbone Providers and/or Local Infrastructure Providers), to a Fixed Hotspot Access Network, to one or more End User Device, and to the Environment (e.g., to any one of more of the sensors or systems discussed herein, any other device or machine, etc.). Though the Mobile Hotspot Access Network is not shown having a wired link to the various other components, there may (at least at times) be such a wired link, at least temporarily.

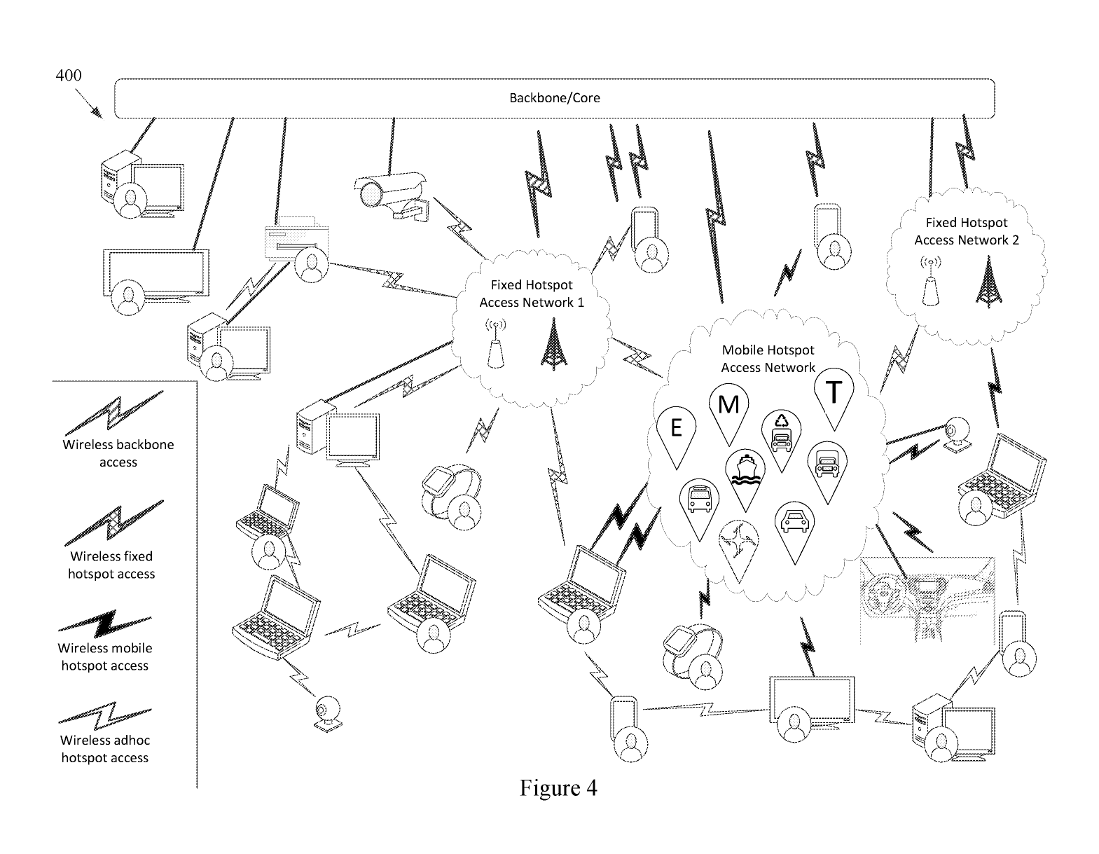

The example network 100 of FIG. 1 also comprises a set of End-User Devices. Various example end user devices are shown at FIG. 4. Note that various other network components (e.g., Fixed Hotspot Access Networks, Mobile Hotspot Access Network(s), the Backbone/Core, etc.) are also illustrated. The example network 400 may, for example, share any or all characteristics with the other example networks and/or network components 100, 200, 300, 500-570, and 600, discussed herein.

The example network 400 shows various mobile networked devices. Such network devices may comprise end-user devices (e.g., smartphones, tablets, smartwatches, laptop computers, webcams, personal gaming devices, personal navigation devices, personal media devices, personal cameras, health-monitoring devices, personal location devices, monitoring panels, printers, etc.). Such networked devices may also comprise any of a variety of devices operating in the general environment, where such devices might not for example be associated with a particular user (e.g. any or all of the sensor devices discussed herein, vehicle sensors, municipal sensors, fleet sensors road sensors, environmental sensors, security sensors, traffic sensors, waste sensors, meteorological sensors, any of a variety of different types of municipal or enterprise equipment, etc.). Any of such networked devices can be flexibly connected to distinct backbone, fixed hotspot access networks, mobile hotspot access networks, etc., using the same or different wired/wireless technologies.

A mobile device may, for example, operate as an AP to provide simultaneous access to multiple devices/things, which may then form ad hoc networks, interconnecting devices ultimately connected to distinct backbone networks, fixed hotspot, and/or mobile hotspot access networks. Devices (e.g., any or all of the devices or network nodes discussed herein) may, for example, have redundant technologies to access distinct backbone, fixed hotspot, and/or mobile hotspot access networks, for example for fault-tolerance and/or load-balancing purposes (e.g., utilizing multiple SIM cards, etc.). A device may also, for example, simultaneously access distinct backbone, fixed hotspot access networks, and/or mobile hotspot access networks, belonging to the same provider or to different respective providers. Additionally for example, a device can provide multiple accesses to another device/thing (e.g., via different channels, radios, etc.).

Referring back to FIG. 1, the example End-User Devices are shown with a wireless communication link to a backbone provider (e.g., to one or more Backbone Providers and/or Local Infrastructure Providers), to a Fixed Hotspot Access Network, to a Mobile Hotspot Access Network, and to the Environment. Also for example, the example End-User Devices are shown with a wired communication link to a backbone provider, to a Fixed Hotspot Access Network, to a Mobile Hotspot Access Network, and to the Environment.

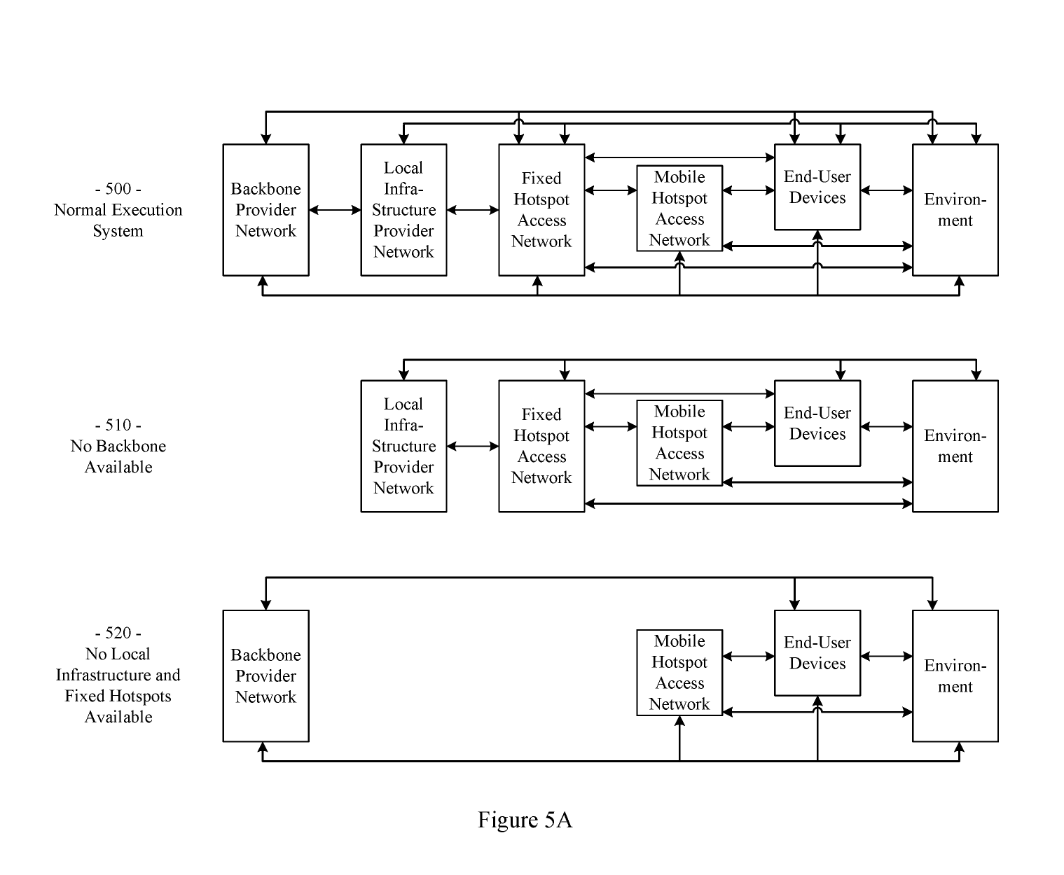

The example network 100 illustrated in FIG. 1 has a flexible architecture that is adaptable at implementation time (e.g., for different use cases) and/or adaptable in real-time, for example as network components enter and leave service. FIGS. 5A-5C illustrate such flexibility by providing example modes (or configurations). The example networks 500-570 may, for example, share any or all characteristics with the other example networks and/or network components 100, 200, 300, 400, and 600, discussed herein. For example and without limitation, any or all of the communication links (e.g., wired links, wireless links, etc.) shown in the example networks 500-570 are generally analogous to similarly positioned communication links shown in the example network 100 of FIG. 1.

For example, various aspects of this disclosure provide communication network architectures, systems, and methods for supporting a dynamically configurable communication network comprising a complex array of both static and moving communication nodes (e.g., the Internet of moving things). For example, a communication network implemented in accordance with various aspects of the present disclosure may operate in one of a plurality of modalities comprising various fixed nodes, mobile nodes, and/or a combination thereof, which are selectable to yield any of a variety of system goals (e.g., increased throughput, reduced latency and packet loss, increased availability and robustness of the system, extra redundancy, increased responsiveness, increased security in the transmission of data and/or control packets, reduced number of configuration changes by incorporating smart thresholds (e.g., change of technology, change of certificate, change of IP, etc.), providing connectivity in dead zones or zones with difficult access, reducing the costs for maintenance and accessing the equipment for updating/upgrading, etc.). At least some of such modalities may, for example, be entirely comprised of fixed-position nodes, at least temporarily if not permanently.

For illustrative simplicity, many of the example aspects shown in the example system or network 100 of FIG. 1 (and other Figures herein) are omitted from FIGS. 5A-5C, but may be present. For example, the Cloud, Internet, and ISP aspects shown in FIG. 1 and in other Figures are not explicitly shown in FIGS. 5A-5C, but may be present in any of the example configurations (e.g., as part of the backbone provider network or coupled thereto, as part of the local infrastructure provider network or coupled thereto, etc.).

For example, the first example mode 500 is presented as a normal execution mode, for example a mode (or configuration) in which all of the components discussed herein are present. For example, the communication system in the first example mode 500 comprises a backbone provider network, a local infrastructure provider network, a fixed hotspot access network, a mobile hotspot access network, end-user devices, and environment devices.

As shown in FIG. 5A, and in FIG. 1 in more detail, the backbone provider network may be communicatively coupled to any or all of the other elements present in the first example mode 500 (or configuration) via one or more wired (or tethered) links. For example, the backbone provider network may be communicatively coupled to the local infrastructure provider network (or any component thereof), fixed hotspot access network (or any component thereof), the end-user devices, and/or environment devices via a wired link. Note that such a wired coupling may be temporary. Also note that in various example configurations, the backbone provider network may also, at least temporarily, be communicatively coupled to the mobile hotspot access network (or any component thereof) via one or more wired (or tethered) links.

Also shown in FIG. 5A, and in FIG. 1 in more detail, the backbone provider network may be communicatively coupled to any or all of the other elements present in the first example mode 500 (or configuration) via one or more wireless links (e.g., RF link, non-tethered optical link, etc.). For example, the backbone provider network may be communicatively coupled to the fixed hotspot access network (or any component thereof), the mobile hotspot access network (or any component thereof), the end-user devices, and/or environment devices via one or more wireless links. Also note that in various example configurations, the backbone provider network may also be communicatively coupled to the local infrastructure provider network via one or more wireless (or non-tethered) links.

Though not shown in the first example mode 500 (or any of the example modes of FIGS. 5A-5C), one or more servers may be communicatively coupled to the backbone provider network and/or the local infrastructure network. FIG. 1 provides an example of cloud servers being communicatively coupled to the backbone provider network via the Internet.

As additionally shown in FIG. 5A, and in FIG. 1 in more detail, the local infrastructure provider network may be communicatively coupled to any or all of the other elements present in the first example mode 500 (or configuration) via one or more wired (or tethered) links. For example, the local infrastructure provider network may be communicatively coupled to the backbone provider network (or any component thereof), fixed hotspot access network (or any component thereof), the end-user devices, and/or environment devices via one or more wired links. Note that such a wired coupling may be temporary. Also note that in various example configurations, the local infrastructure provider network may also, at least temporarily, be communicatively coupled to the mobile hotspot access network (or any component thereof) via one or more wired (or tethered) links.

Also, though not explicitly shown, the local infrastructure provider network may be communicatively coupled to any or all of the other elements present in the first example mode 500 (or configuration) via one or more wireless links (e.g., RF link, non-tethered optical link, etc.). For example, the local infrastructure provider network may be communicatively coupled to the backbone provider network (or any component thereof), the fixed hotspot access network (or any component thereof), the mobile hotspot access network (or any component thereof), the end-user devices, and/or environment devices via one or more wireless links. Note that the communication link shown in the first example mode 500 of FIG. 5A between the local infrastructure provider network and the fixed hotspot access network may be wired and/or wireless.

The fixed hotspot access network is also shown in the first example mode 500 to be communicatively coupled to the mobile hotspot access network, the end-user devices, and/or environment devices via one or more wireless links. Many examples of such wireless coupling are provided herein. Additionally, the mobile hotspot access network is further shown in the first example mode 500 to be communicatively coupled to the end-user devices and/or environment devices via one or more wireless links. Many examples of such wireless coupling are provided herein. Further, the end-user devices are also shown in the first example mode 500 to be communicatively coupled to the environment devices via one or more wireless links. Many examples of such wireless coupling are provided herein. Note that in various example implementations any of such wireless links may instead (or in addition) comprise a wired (or tethered) link.

In the first example mode 500 (e.g., the normal mode), information (or data) may be communicated between an end-user device and a server (e.g., a computer system) via the mobile hotspot access network, the fixed hotspot access network, the local infrastructure provider network, and/or the backbone provider network. As will be seen in the various example modes presented herein, such communication may flexibly occur between an end-user device and a server via any of a variety of different communication pathways, for example depending on the availability of a network, depending on bandwidth utilization goals, depending on communication priority, depending on communication time (or latency) and/or reliability constraints, depending on cost, etc. For example, information communicated between an end user device and a server may be communicated via the fixed hotspot access network, the local infrastructure provider network, and/or the backbone provider network (e.g., skipping the mobile hotspot access network). Also for example, information communicated between an end user device and a server may be communicated via the backbone provider network (e.g., skipping the mobile hotspot access network, fixed hotspot access network, and/or local infrastructure provider network).

Similarly, in the first example mode 500 (e.g., the normal mode), information (or data) may be communicated between an environment device and a server via the mobile hotspot access network, the fixed hotspot access network, the local infrastructure provider network, and/or the backbone provider network. Also for example, an environment device may communicate with or through an end-user device (e.g., instead of or in addition to the mobile hotspot access network). As will be seen in the various example modes presented herein, such communication may flexibly occur between an environment device and a server (e.g., communicatively coupled to the local infrastructure provider network and/or backbone provider network) via any of a variety of different communication pathways, for example depending on the availability of a network, depending on bandwidth utilization goals, depending on communication priority, depending on communication time (or latency) and/or reliability constraints, depending on cost, etc.

For example, information communicated between an environment device and a server may be communicated via the fixed hotspot access network, the local infrastructure provider network, and/or the backbone provider network (e.g., skipping the mobile hotspot access network). Also for example, information communicated between an environment device and a server may be communicated via the backbone provider network (e.g., skipping the mobile hotspot access network, fixed hotspot access network, and/or local infrastructure provider network). Additionally for example, information communicated between an environment device and a server may be communicated via the local infrastructure provider network (e.g., skipping the mobile hotspot access network and/or fixed hotspot access network).

As discussed herein, the example networks presented herein are adaptively configurable to operate in any of a variety of different modes (or configurations). Such adaptive configuration may occur at initial installation and/or during subsequent controlled network evolution (e.g., adding or removing any or all of the network components discussed herein, expanding or removing network capacity, adding or removing coverage areas, adding or removing services, etc.). Such adaptive configuration may also occur in real-time, for example in response to real-time changes in network conditions (e.g., networks or components thereof being available or not based on vehicle or user-device movement, network or component failure, network or component replacement or augmentation activity, network overloading, etc.). The following example modes are presented to illustrate characteristics of various modes in which a communication system may operate in accordance with various aspects of the present disclosure. The following example modes will generally be discussed in relation to the first example mode 500 (e.g., the normal execution mode). Note that such example modes are merely illustrative and not limiting.

The second example mode (or configuration) 510 (e.g., a no backbone available mode) may, for example, share any or all characteristics with the first example mode 500, albeit without the backbone provider network and communication links therewith. For example, the communication system in the second example mode 510 comprises a local infrastructure provider network, a fixed hotspot access network, a mobile hotspot access network, end-user devices, and environment devices.

As shown in FIG. 5A, and in FIG. 1 in more detail, the local infrastructure provider network may be communicatively coupled to any or all of the other elements present in the second example mode 510 (or configuration) via one or more wired (or tethered) links. For example, the local infrastructure provider network may be communicatively coupled to the fixed hotspot access network (or any component thereof), the end-user devices, and/or environment devices via one or more wired links. Note that such a wired coupling may be temporary. Also note that in various example configurations, the local infrastructure provider network may also, at least temporarily, be communicatively coupled to the mobile hotspot access network (or any component thereof) via one or more wired (or tethered) links.

Also, though not explicitly shown, the local infrastructure provider network may be communicatively coupled to any or all of the other elements present in the second example mode 510 (or configuration) via one or more wireless links (e.g., RF link, non-tethered optical link, etc.). For example, the local infrastructure provider network may be communicatively coupled to the fixed hotspot access network (or any component thereof), the mobile hotspot access network (or any component thereof), the end-user devices, and/or environment devices via one or more wireless links. Note that the communication link(s) shown in the second example mode 510 of FIG. 5A between the local infrastructure provider network and the fixed hotspot access network may be wired and/or wireless.

The fixed hotspot access network is also shown in the second example mode 510 to be communicatively coupled to the mobile hotspot access network, the end-user devices, and/or environment devices via one or more wireless links. Many examples of such wireless coupling are provided herein. Additionally, the mobile hotspot access network is further shown in the second example mode 510 to be communicatively coupled to the end-user devices and/or environment devices via one or more wireless links. Many examples of such wireless coupling are provided herein. Further, the end-user devices are also shown in the second example mode 510 to be communicatively coupled to the environment devices via one or more wireless links. Many examples of such wireless coupling are provided herein. Note that in various example implementations any of such wireless links may instead (or in addition) comprise a wired (or tethered) link.

In the second example mode 510 (e.g., the no backbone available mode), information (or data) may be communicated between an end-user device and a server (e.g., a computer, etc.) via the mobile hotspot access network, the fixed hotspot access network, and/or the local infrastructure provider network. As will be seen in the various example modes presented herein, such communication may flexibly occur between an end-user device and a server via any of a variety of different communication pathways, for example depending on the availability of a network, depending on bandwidth utilization goals, depending on communication priority, depending on communication time (or latency) and/or reliability constraints, depending on cost, etc. For example, information communicated between an end user device and a server may be communicated via the fixed hotspot access network and/or the local infrastructure provider network (e.g., skipping the mobile hotspot access network). Also for example, information communicated between an end user device and a server may be communicated via the local infrastructure provider network (e.g., skipping the mobile hotspot access network and/or fixed hotspot access network).

Similarly, in the second example mode 510 (e.g., the no backbone available mode), information (or data) may be communicated between an environment device and a server via the mobile hotspot access network, the fixed hotspot access network, and/or the local infrastructure provider network. Also for example, an environment device may communicate with or through an end-user device (e.g., instead of or in addition to the mobile hotspot access network). As will be seen in the various example modes presented herein, such communication may flexibly occur between an environment device and a server (e.g., communicatively coupled to the local infrastructure provider network) via any of a variety of different communication pathways, for example depending on the availability of a network, depending on bandwidth utilization goals, depending on communication priority, depending on communication time (or latency) and/or reliability constraints, depending on cost, etc.

For example, information communicated between an environment device and a server may be communicated via the fixed hotspot access network and/or the local infrastructure provider network (e.g., skipping the mobile hotspot access network). Also for example, information communicated between an environment device and a server may be communicated via the local infrastructure provider network (e.g., skipping the mobile hotspot access network and/or fixed hotspot access network).

The second example mode 510 may be utilized for any of a variety of reasons, non-limiting examples of which are provided herein. For example, due to security and/or privacy goals, the second example mode 510 may be utilized so that communication access to the public Cloud systems, the Internet in general, etc., is not allowed. For example, all network control and management functions may be within the local infrastructure provider network (e.g., wired local network, etc.) and/or the fixed access point network.

In an example implementation, the communication system might be totally owned, operated and/or controlled by a local port authority. No extra expenses associated with cellular connections need be spent. For example, cellular connection capability (e.g., in Mobile APs, Fixed APs, end user devices, environment devices, etc.) need not be provided. Note also that the second example mode 510 may be utilized in a scenario in which the backbone provider network is normally available but is currently unavailable (e.g., due to server failure, due to communication link failure, due to power outage, due to a temporary denial of service, etc.).

The third example mode (or configuration) 520 (e.g., a no local infrastructure and fixed hotspots available mode) may, for example, share any or all characteristics with the first example mode 500, albeit without the local infrastructure provider network, the fixed hotspot access network, and communication links therewith. For example, the communication system in the third example mode 520 comprises a backbone provider network, a mobile hotspot access network, end-user devices, and environment devices.

As shown in FIG. 5A, and in FIG. 1 in more detail, the backbone provider network may be communicatively coupled to any or all of the other elements present in the third example mode 520 (or configuration) via one or more wired (or tethered) links. For example, the backbone provider network may be communicatively coupled to the end-user devices and/or environment devices via one or more wired links. Note that such a wired coupling may be temporary. Also note that in various example configurations, the backbone provider network may also, at least temporarily, be communicatively coupled to the mobile hotspot access network (or any component thereof) via one or more wired (or tethered) links.

Also shown in FIG. 5A, and in FIG. 1 in more detail, the backbone provider network may be communicatively coupled to any or all of the other elements present in the third example mode 520 (or configuration) via one or more wireless links (e.g., RF link, non-tethered optical link, etc.). For example, the backbone provider network may be communicatively coupled to the mobile hotspot access network (or any component thereof), the end-user devices, and/or environment devices via one or more wireless links.

The mobile hotspot access network is further shown in the third example mode 520 to be communicatively coupled to the end-user devices and/or environment devices via one or more wireless links. Many examples of such wireless coupling are provided herein. Further, the end-user devices are also shown in the third example mode 520 to be communicatively coupled to the environment devices via one or more wireless links. Many examples of such wireless coupling are provided herein. Note that in various example implementations any of such wireless links may instead (or in addition) comprise a wired (or tethered) link.

In the third example mode 520 (e.g., the no local infrastructure and fixed hotspots available mode), information (or data) may be communicated between an end-user device and a server (e.g., a computer, etc.) via the mobile hotspot access network and/or the backbone provider network. As will be seen in the various example modes presented herein, such communication may flexibly occur between an end-user device and a server via any of a variety of different communication pathways, for example depending on the availability of a network, depending on bandwidth utilization goals, depending on communication priority, depending on communication time (or latency) and/or reliability constraints, depending on cost, etc. For example, information communicated between an end user device and a server may be communicated via the backbone provider network (e.g., skipping the mobile hotspot access network).

Similarly, in the third example mode 520 (e.g., the no local infrastructure and fixed hotspots available mode), information (or data) may be communicated between an environment device and a server via the mobile hotspot access network and/or the backbone provider network. Also for example, an environment device may communicate with or through an end-user device (e.g., instead of or in addition to the mobile hotspot access network). As will be seen in the various example modes presented herein, such communication may flexibly occur between an environment device and a server (e.g., communicatively coupled to the backbone provider network) via any of a variety of different communication pathways, for example depending on the availability of a network, depending on bandwidth utilization goals, depending on communication priority, depending on communication time (or latency) and/or reliability constraints, depending on cost, etc. For example, information communicated between an environment device and a server may be communicated via the backbone provider network (e.g., skipping the mobile hotspot access network).

In the third example mode 520, all control/management functions may for example be implemented within the Cloud. For example, since the mobile hotspot access network does not have a communication link via a fixed hotspot access network, the Mobile APs may utilize a direct connection (e.g., a cellular connection) with the backbone provider network (or Cloud). If a Mobile AP does not have such capability, the Mobile AP may also, for example, utilize data access provided by the end-user devices communicatively coupled thereto (e.g., leveraging the data plans of the end-user devices).

The third example mode 520 may be utilized for any of a variety of reasons, non-limiting examples of which are provided herein. In an example implementation, the third example mode 520 may be utilized in an early stage of a larger deployment, for example deployment that will grow into another mode (e.g., the example first mode 500, example fourth mode 530, etc.) as more communication system equipment is installed. Note also that the third example mode 520 may be utilized in a scenario in which the local infrastructure provider network and fixed hotspot access network are normally available but are currently unavailable (e.g., due to equipment failure, due to communication link failure, due to power outage, due to a temporary denial of service, etc.).

The fourth example mode (or configuration) 530 (e.g., a no fixed hotspots available mode) may, for example, share any or all characteristics with the first example mode 500, albeit without the fixed hotspot access network and communication links therewith. For example, the communication system in the fourth example mode 530 comprises a backbone provider network, a local infrastructure provider network, a mobile hotspot access network, end-user devices, and environment devices.

As shown in FIG. 5B, and in FIG. 1 in more detail, the backbone provider network may be communicatively coupled to any or all of the other elements present in the fourth example mode 530 (or configuration) via one or more wired (or tethered) links. For example, the backbone provider network may be communicatively coupled to the local infrastructure provider network (or any component thereof), the end-user devices, and/or environment devices via one or more wired links. Note that such a wired coupling may be temporary. Also note that in various example configurations, the backbone provider network may also, at least temporarily, be communicatively coupled to the mobile hotspot access network (or any component thereof) via one or more wired (or tethered) links.

Also shown in FIG. 5B, and in FIG. 1 in more detail, the backbone provider network may be communicatively coupled to any or all of the other elements present in the fourth example mode 530 (or configuration) via one or more wireless links (e.g., RF link, non-tethered optical link, etc.). For example, the backbone provider network may be communicatively coupled to the mobile hotspot access network (or any component thereof), the end-user devices, and/or environment devices via one or more wireless links. Also note that in various example configurations, the backbone provider network may also be communicatively coupled to the local infrastructure provider network via one or more wireless (or non-tethered) links.

As additionally shown in FIG. 5B, and in FIG. 1 in more detail, the local infrastructure provider network may be communicatively coupled to any or all of the other elements present in the fourth example mode 530 (or configuration) via one or more wired (or tethered) links. For example, the local infrastructure provider network may be communicatively coupled to the backbone provider network (or any component thereof), the end-user devices, and/or environment devices via one or more wired links. Note that such a wired coupling may be temporary. Also note that in various example configurations, the local infrastructure provider network may also, at least temporarily, be communicatively coupled to the mobile hotspot access network (or any component thereof) via one or more wired (or tethered) links.

Also, though not explicitly shown, the local infrastructure provider network may be communicatively coupled to any or all of the other elements present in the fourth example mode 530 (or configuration) via one or more wireless links (e.g., RF link, non-tethered optical link, etc.). For example, the local infrastructure provider network may be communicatively coupled to the backbone provider network (or any component thereof), the mobile hotspot access network (or any component thereof), the end-user devices, and/or environment devices via one or more wireless links.

The mobile hotspot access network is further shown in the fourth example mode 530 to be communicatively coupled to the end-user devices and/or environment devices via one or more wireless links. Many examples of such wireless coupling are provided herein. Further, the end-user devices are also shown in the fourth example mode 530 to be communicatively coupled to the environment devices via one or more wireless links. Many examples of such wireless coupling are provided herein.

In the fourth example mode 530 (e.g., the no fixed hotspots mode), information (or data) may be communicated between an end-user device and a server via the mobile hotspot access network, the local infrastructure provider network, and/or the backbone provider network. As will be seen in the various example modes presented herein, such communication may flexibly occur between an end-user device and a server via any of a variety of different communication pathways, for example depending on the availability of a network, depending on bandwidth utilization goals, depending on communication priority, depending on communication time (or latency) and/or reliability constraints, depending on cost, etc. For example, information communicated between an end user device and a server may be communicated via the local infrastructure provider network and/or the backbone provider network (e.g., skipping the mobile hotspot access network). Also for example, information communicated between an end user device and a server may be communicated via the backbone provider network (e.g., skipping the mobile hotspot access network and/or local infrastructure provider network).

Similarly, in the fourth example mode 530 (e.g., the no fixed hotspots available mode), information (or data) may be communicated between an environment device and a server via the mobile hotspot access network, the local infrastructure provider network, and/or the backbone provider network. Also for example, an environment device may communicate with or through an end-user device (e.g., instead of or in addition to the mobile hotspot access network). As will be seen in the various example modes presented herein, such communication may flexibly occur between an environment device and a server (e.g., communicatively coupled to the local infrastructure provider network and/or backbone provider network) via any of a variety of different communication pathways, for example depending on the availability of a network, depending on bandwidth utilization goals, depending on communication priority, depending on communication time (or latency) and/or reliability constraints, depending on cost, etc.

For example, information communicated between an environment device and a server may be communicated via the local infrastructure provider network and/or the backbone provider network (e.g., skipping the mobile hotspot access network). Also for example, information communicated between an environment device and a server may be communicated via the backbone provider network (e.g., skipping the mobile hotspot access network and/or local infrastructure provider network). Additionally for example, information communicated between an environment device and a server may be communicated via the local infrastructure provider network (e.g., skipping the mobile hotspot access network and/or backbone provider network).

In the fourth example mode 530, in an example implementation, some of the control/management functions may for example be implemented within the local backbone provider network (e.g., within a client premises). For example, communication to the local infrastructure provider may be performed through the backbone provider network (or Cloud). Note that in a scenario in which there is a direct communication pathway between the local infrastructure provider network and the mobile hotspot access network, such communication pathway may be utilized.

For example, since the mobile hotspot access network does not have a communication link via a fixed hotspot access network, the Mobile APs may utilize a direct connection (e.g., a cellular connection) with the backbone provider network (or Cloud). If a Mobile AP does not have such capability, the Mobile AP may also, for example, utilize data access provided by the end-user devices communicatively coupled thereto (e.g., leveraging the data plans of the end-user devices).

The fourth example mode 530 may be utilized for any of a variety of reasons, non-limiting examples of which are provided herein. In an example implementation, the fourth example mode 530 may be utilized in an early stage of a larger deployment, for example a deployment that will grow into another mode (e.g., the example first mode 500, etc.) as more communication system equipment is installed. The fourth example mode 530 may, for example, be utilized in a scenario in which there is no fiber (or other) connection available for Fixed APs (e.g., in a maritime scenario, in a plantation scenario, etc.), or in which a Fixed AP is difficult to access or connect. For example, one or more Mobile APs of the mobile hotspot access network may be used as gateways to reach the Cloud. The fourth example mode 530 may also, for example, be utilized when a vehicle fleet and/or the Mobile APs associated therewith are owned by a first entity and the Fixed APs are owned by another entity, and there is no present agreement for communication between the Mobile APs and the Fixed APs. Note also that the fourth example mode 530 may be utilized in a scenario in which the fixed hotspot access network is normally available but are currently unavailable (e.g., due to equipment failure, due to communication link failure, due to power outage, due to a temporary denial of service, etc.).

The fifth example mode (or configuration) 540 (e.g., a no mobile hotspots available mode) may, for example, share any or all characteristics with the first example mode 500, albeit without the mobile hotspot access network and communication links therewith. For example, the communication system in the fifth example mode 540 comprises a backbone provider network, a local infrastructure provider network, a fixed hotspot access network, end-user devices, and environment devices.

As shown in FIG. 5B, and in FIG. 1 in more detail, the backbone provider network may be communicatively coupled to any or all of the other elements present in the fifth example mode 540 (or configuration) via one or more wired (or tethered) links. For example, the backbone provider network may be communicatively coupled to the local infrastructure provider network (or any component thereof), fixed hotspot access network (or any component thereof), the end-user devices, and/or environment devices via one or more wired links. Note that such a wired coupling may be temporary.

Also shown in FIG. 5B, and in FIG. 1 in more detail, the backbone provider network may be communicatively coupled to any or all of the other elements present in the fifth example mode 540 (or configuration) via one or more wireless links (e.g., RF link, non-tethered optical link, etc.). For example, the backbone provider network may be communicatively coupled to the fixed hotspot access network (or any component thereof), the end-user devices, and/or environment devices via one or more wireless links. Also note that in various example configurations, the backbone provider network may also be communicatively coupled to the local infrastructure provider network via one or more wireless (or non-tethered) links.

As additionally shown in FIG. 5B, and in FIG. 1 in more detail, the local infrastructure provider network may be communicatively coupled to any or all of the other elements present in the fifth example mode 540 (or configuration) via one or more wired (or tethered) links. For example, the local infrastructure provider network may be communicatively coupled to the backbone provider network (or any component thereof), fixed hotspot access network (or any component thereof), the end-user devices, and/or environment devices via one or more wired links. Note that such a wired coupling may be temporary. Also note that in various example configurations, the local infrastructure provider network may also, at least temporarily, be communicatively coupled to the mobile hotspot access network (or any component thereof) via one or more wired (or tethered) links.

Also, though not explicitly shown, the local infrastructure provider network may be communicatively coupled to any or all of the other elements present in the fifth example mode 540 (or configuration) via one or more wireless links (e.g., RF link, non-tethered optical link, etc.). For example, the local infrastructure provider network may be communicatively coupled to the backbone provider network, the fixed hotspot access network (or any component thereof), the end-user devices, and/or environment devices via one or more wireless links. Note that the communication link(s) shown in the fifth example mode 540 of FIG. 5B between the local infrastructure provider network and the fixed hotspot access network may be wired and/or wireless.

The fixed hotspot access network is also shown in the fifth example mode 540 to be communicatively coupled to the end-user devices and/or environment devices via one or more wireless links. Many examples of such wireless coupling are provided herein. Further, the end-user devices are also shown in the fifth example mode 540 to be communicatively coupled to the environment devices via one or more wireless links. Many examples of such wireless coupling are provided herein.

In the fifth example mode 540 (e.g., the no mobile hotspots available mode), information (or data) may be communicated between an end-user device and a server via the fixed hotspot access network, the local infrastructure provider network, and/or the backbone provider network. As will be seen in the various example modes presented herein, such communication may flexibly occur between an end-user device and a server via any of a variety of different communication pathways, for example depending on the availability of a network, depending on bandwidth utilization goals, depending on communication priority, depending on communication time (or latency) and/or reliability constraints, depending on cost, etc. For example, information communicated between an end user device and a server may be communicated via the local infrastructure provider network, and/or the backbone provider network (e.g., skipping the fixed hotspot access network). Also for example, information communicated between an end user device and a server may be communicated via the backbone provider network (e.g., skipping the fixed hotspot access network and/or local infrastructure provider network).

Similarly, in the fifth example mode 540 (e.g., the no mobile hotspots available mode), information (or data) may be communicated between an environment device and a server via the fixed hotspot access network, the local infrastructure provider network, and/or the backbone provider network. Also for example, an environment device may communicate with or through an end-user device (e.g., instead of or in addition to the fixed hotspot access network). As will be seen in the various example modes presented herein, such communication may flexibly occur between an environment device and a server (e.g., communicatively coupled to the local infrastructure provider network and/or backbone provider network) via any of a variety of different communication pathways, for example depending on the availability of a network, depending on bandwidth utilization goals, depending on communication priority, depending on communication time (or latency) and/or reliability constraints, depending on cost, etc.

For example, information communicated between an environment device and a server may be communicated via the local infrastructure provider network and/or the backbone provider network (e.g., skipping the fixed hotspot access network). Also for example, information communicated between an environment device and a server may be communicated via the backbone provider network (e.g., skipping the fixed hotspot access network and/or local infrastructure provider network). Additionally for example, information communicated between an environment device and a server may be communicated via the local infrastructure provider network (e.g., skipping the fixed hotspot access network and/or the backbone provider network).

In the fifth example mode 540, in an example implementation, the end-user devices and environment devices may communicate directly to Fixed APs (e.g., utilizing Ethernet, Wi-Fi, etc.). Also for example, the end-user devices and/or environment devices may communicate directly with the backbone provider network (e.g., utilizing cellular connections, etc.).

The fifth example mode 540 may be utilized for any of a variety of reasons, non-limiting examples of which are provided herein. In an example implementation in which end-user devices and/or environment devices may communicate directly with Fixed APs, such communication may be utilized instead of Mobile AP communication. For example, the fixed hotspot access network might provide coverage for all desired areas.

Note also that the fifth example mode 540 may be utilized in a scenario in which the fixed hotspot access network is normally available but is currently unavailable (e.g., due to equipment failure, due to communication link failure, due to power outage, due to a temporary denial of service, etc.).

The sixth example mode (or configuration) 550 (e.g., the no fixed/mobile hotspots and local infrastructure available mode) may, for example, share any or all characteristics with the first example mode 500, albeit without the local infrastructure provider network, fixed hotspot access network, mobile hotspot access network, and communication links therewith. For example, the communication system in the sixth example mode 550 comprises a backbone provider network, end-user devices, and environment devices.

As shown in FIG. 5B, and in FIG. 1 in more detail, the backbone provider network may be communicatively coupled to any or all of the other elements present in the sixth example mode 550 (or configuration) via one or more wired (or tethered) links. For example, the backbone provider network may be communicatively coupled to the end-user devices and/or environment devices via one or more wired links. Note that such a wired coupling may be temporary.

Also shown in FIG. 5B, and in FIG. 1 in more detail, the backbone provider network may be communicatively coupled to any or all of the other elements present in the sixth example mode 550 (or configuration) via one or more wireless links (e.g., RF link, non-tethered optical link, etc.). For example, the backbone provider network may be communicatively coupled to the end-user devices and/or environment devices via one or more wireless links.

The end-user devices are also shown in the sixth example mode 550 to be communicatively coupled to the environment devices via one or more wireless links. Many examples of such wireless coupling are provided herein.

In the sixth example mode 550 (e.g., the no fixed/mobile hotspots and local infrastructure available mode), information (or data) may be communicated between an end-user device and a server via the backbone provider network. Similarly, in the sixth example mode 550 (e.g., the no fixed/mobile hotspots and local infrastructure mode), information (or data) may be communicated between an environment device and a server via the backbone provider network. Also for example, an environment device may communicate with or through an end-user device (e.g., instead of or in addition to the mobile hotspot access network).

The sixth example mode 550 may be utilized for any of a variety of reasons, non-limiting examples of which are provided herein. In an example implementation, for example in which an end-user has not yet subscribed to the communication system, the end-user device may subscribe to the system through a Cloud application and by communicating directly with the backbone provider network (e.g., via cellular link, etc.). The sixth example mode 550 may also, for example, be utilized in rural areas in which Mobile AP presence is sparse, Fixed AP installation is difficult or impractical, etc.

Note also that the sixth example mode 550 may be utilized in a scenario in which the infrastructure provider network, fixed hotspot access network, and/or mobile hotspot access network are normally available but are currently unavailable (e.g., due to equipment failure, due to communication link failure, due to power outage, due to a temporary denial of service, etc.).

The seventh example mode (or configuration) 560 (e.g., the no backbone and mobile hotspots available mode) may, for example, share any or all characteristics with the first example mode 500, albeit without the backbone provider network, mobile hotspot access network, and communication links therewith. For example, the communication system in the seventh example mode 560 comprises a local infrastructure provider network, fixed hotspot access network, end-user devices, and environment devices.

As shown in FIG. 5C, and in FIG. 1 in more detail, the local infrastructure provider network may be communicatively coupled to any or all of the other elements present in the seventh example mode 560 (or configuration) via one or more wired (or tethered) links. For example, the local infrastructure provider network may be communicatively coupled to the fixed hotspot access network (or any component thereof), the end-user devices, and/or environment devices via one or more wired links. Note that such a wired coupling may be temporary.

Also, though not explicitly shown, the local infrastructure provider network may be communicatively coupled to any or all of the other elements present in the seventh example mode 560 (or configuration) via one or more wireless links (e.g., RF link, non-tethered optical link, etc.). For example, the local infrastructure provider network may be communicatively coupled to the fixed hotspot access network (or any component thereof), the end-user devices, and/or environment devices via one or more wireless links. Note that the communication link shown in the seventh example mode 560 of FIG. 5C between the local infrastructure provider network and the fixed hotspot access network may be wired and/or wireless.

The fixed hotspot access network is also shown in the seventh example mode 560 to be communicatively coupled to the end-user devices and/or environment devices via one or more wireless links. Many examples of such wireless coupling are provided herein. Additionally, the end-user devices are also shown in the seventh example mode 560 to be communicatively coupled to the environment devices via one or more wireless links. Many examples of such wireless coupling are provided herein.

In the seventh example mode 560 (e.g., the no backbone and mobile hotspots available mode), information (or data) may be communicated between an end-user device and a server via the fixed hotspot access network and/or the local infrastructure provider network. As will be seen in the various example modes presented herein, such communication may flexibly occur between an end-user device and a server via any of a variety of different communication pathways, for example depending on the availability of a network, depending on bandwidth utilization goals, depending on communication priority, depending on communication time (or latency) and/or reliability constraints, depending on cost, etc. For example, information communicated between an end user device and a server may be communicated via the local infrastructure provider network (e.g., skipping the fixed hotspot access network).

Similarly, in the seventh example mode 560 (e.g., the no backbone and mobile hotspots available mode), information (or data) may be communicated between an environment device and a server via the fixed hotspot access network and/or the local infrastructure provider network. Also for example, an environment device may communicate with or through an end-user device (e.g., instead of or in addition to the mobile hotspot access network). As will be seen in the various example modes presented herein, such communication may flexibly occur between an environment device and a server (e.g., communicatively coupled to the local infrastructure provider network) via any of a variety of different communication pathways, for example depending on the availability of a network, depending on bandwidth utilization goals, depending on communication priority, depending on communication time (or latency) and/or reliability constraints, depending on cost, etc. For example, information communicated between an environment device and a server may be communicated via the local infrastructure provider network (e.g., skipping the fixed hotspot access network).

The seventh example mode 560 may be utilized for any of a variety of reasons, non-limiting examples of which are provided herein. In an example controlled space implementation, Cloud access might not be provided (e.g., for security reasons, privacy reasons, etc.), and full (or sufficient) coverage of the coverage area is provided by the fixed hotspot access network, and thus the mobile hotspot access network is not needed. For example, the end-user devices and environment devices may communicate directly (e.g., via Ethernet, Wi-Fi, etc.) with the Fixed APs

Note also that the seventh example mode 560 may be utilized in a scenario in which the backbone provider network and/or fixed hotspot access network are normally available but are currently unavailable (e.g., due to equipment failure, due to communication link failure, due to power outage, due to a temporary denial of service, etc.).

The eighth example mode (or configuration) 570 (e.g., the no backbone, fixed hotspots, and local infrastructure available mode) may, for example, share any or all characteristics with the first example mode 500, albeit without the backbone provider network, local infrastructure provider network, fixed hotspot access network, and communication links therewith. For example, the communication system in the eighth example mode 570 comprises a mobile hotspot access network, end-user devices, and environment devices.

As shown in FIG. 5C, and in FIG. 1 in more detail, the mobile hotspot access network is shown in the eighth example mode 570 to be communicatively coupled to the end-user devices and/or environment devices via one or more wireless links. Many examples of such wireless coupling are provided herein. Further, the end-user devices are also shown in the eighth example mode 570 to be communicatively coupled to the environment devices via one or more wireless links. Many examples of such wireless coupling are provided herein.

In the eighth example mode 570 (e.g., the no backbone, fixed hotspots, and local infrastructure available mode), information (or data) might not (at least currently) be communicated between an end-user device and a server (e.g., a coupled to the backbone provider network, local infrastructure provider network, etc.). Similarly, information (or data) might not (at least currently) be communicated between an environment device and a server (e.g., a coupled to the backbone provider network, local infrastructure provider network, etc.). Note that the environment device may communicate with or through an end-user device (e.g., instead of or in addition to the mobile hotspot access network).

The eighth example mode 570 may be utilized for any of a variety of reasons, non-limiting examples of which are provided herein. In an example implementation, the eighth example mode 570 may be utilized for gathering and/or serving data (e.g., in a delay-tolerant networking scenario), providing peer-to-peer communication through the mobile hotspot access network (e.g., between clients of a single Mobile AP, between clients of respective different Mobile APs, etc.), etc. In another example scenario, the eighth example mode 570 may be utilized in a scenario in which vehicle-to-vehicle communications are prioritized above vehicle-to-infrastructure communications. In yet another example scenario, the eighth example mode 570 may be utilized in a scenario in which all infrastructure access is lost (e.g., in tunnels, parking garages, etc.).

Note also that the eighth example mode 570 may be utilized in a scenario in which the backbone provider network, local infrastructure provider network, and/or fixed hotspot access network are normally available but are currently unavailable (e.g., due to equipment failure, due to communication link failure, due to power outage, due to a temporary denial of service, etc.).

As shown and discussed herein, it is beneficial to have a generic platform that allows multi-mode communications of multiple users or machines within different environments, using multiple devices with multiple technologies, connected to multiple moving/static things with multiple technologies, forming wireless (mesh) hotspot networks over different environments, connected to multiple wired/wireless infrastructure/network backbone providers, ultimately connected to the Internet, Cloud or private network infrastructure.

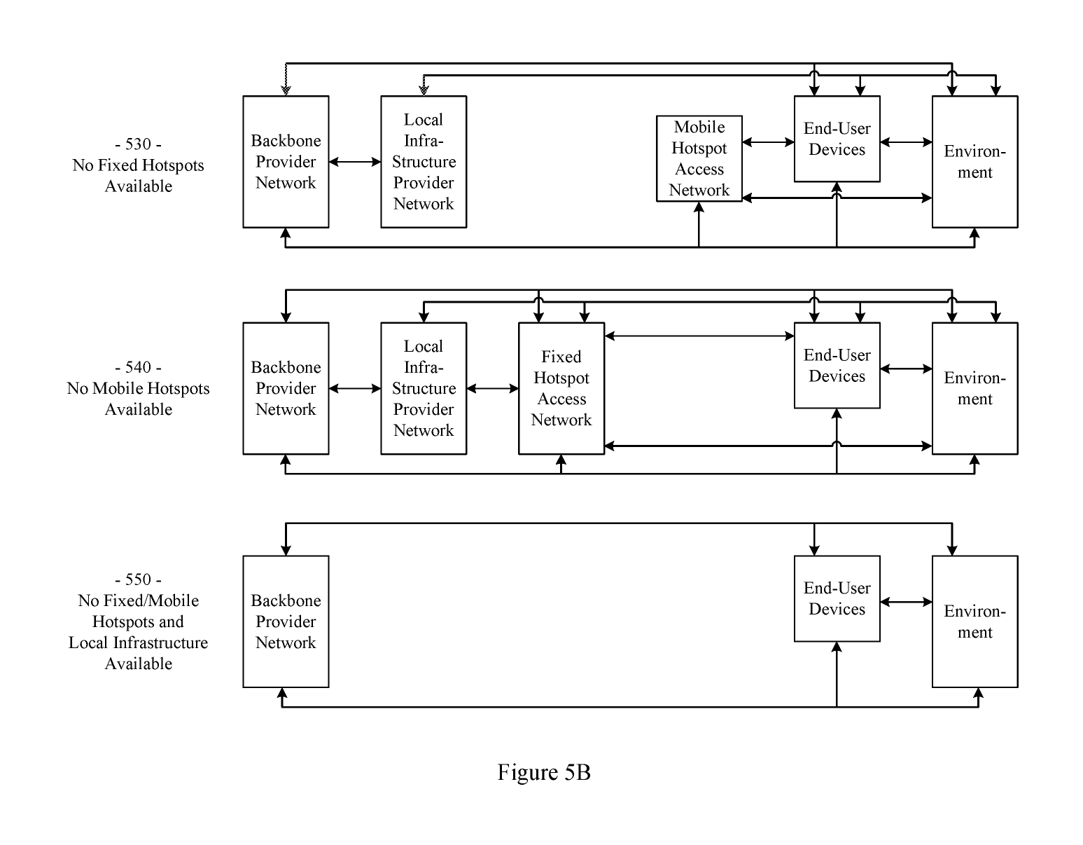

FIG. 6 shows yet another block diagram of an example network configuration, in accordance with various aspects of the present disclosure. The example network 600 may, for example, share any or all characteristics with the other example networks and/or network components 100, 200, 300, 400, and 500-570, discussed herein. Notably, the example network 600 shows a plurality of Mobile APs (or OBUs), each communicatively coupled to a Fixed AP (or RSU), where each Mobile AP may provide network access to a vehicle network (e.g., comprising other vehicles or vehicle networks, user devices, sensor devices, etc.).

In accordance with various aspects of the present disclosure, systems and methods are provided that manage a vehicle communication network, for example in accordance with the location of nodes and end devices, in a way that provides for stable TCP/IP Internet access, among other things. For example, an end user may be provided with a clean and stable Wi-Fi Internet connection that may appear to the end user to be the same as the Wi-Fi Internet connection at the user's home, user's workplace, fixed public Wi-Fi hotspots, etc. For example, for a user utilizing a communication network as described herein, a TCP session may stay active, downloads may process normally, calls may proceed without interruption, etc. As discussed herein, a vehicle communication network in accordance with various aspects of this disclosure may be applied as a transport layer for regular Internet traffic and/or for private network traffic (e.g., extending the access of customer private LANs from the wired network to vehicles and users around them, etc.).

In accordance with an example network implementation, although a user might be always connected to a single Wi-Fi AP of a vehicle, the vehicle (or the access point thereof, for example an OBU) is moving between multiple access points (e.g., Fixed APs, other Mobile APs, cellular base stations, fixed Wi-Fi hotspots, etc.). For example, mobility management implemented in accordance with various aspects of the present disclosure supports the mobility of each vehicle and its users across different communication technologies (e.g., 802.11p, cellular, Wi-Fi, etc.) as the Mobile APs migrate among Fixed APs (and/or Mobile APs) and/or as users migrate between Mobile APs.

In accordance with various aspects of the present disclosure, a mobility controller (MC), which may also be referred to as an LMA or Network Controller, may monitor the location (e.g., network location, etc.) of various nodes (e.g., Mobile APs, etc.) and/or the location of end users connected through them. The mobility controller (MC) may, for example, provide seamless handovers (e.g., maintaining communication session continuity) between different access points and/or different technologies with low link latency and low handover times.

The architecture provided herein is scalable, for example taking advantage of redundant elements and/or functionality to provide load-balancing of control and/or data communication functionality, as well as to decrease failure probability. Various aspects of the present disclosure also provide for decreased control signaling (e.g., in amount and/or frequency), which reduces the control overhead and reduces the size of control tables and tunneling, for example both in backend servers and in APs (e.g., Fixed APs and/or Mobile APs).

Additionally, a communication network (or components thereof) in accordance with various aspects of this disclosure may comprise the ability to interact with mobile devices in order to control some or all of their connection choices and/or to leverage their control functionality. For example, in an example implementation, a mobile application can run in the background, managing the available networks and/or nodes thereof and selecting the one that best fits, and then triggering a handoff to the selected network (or node thereof) before breakdown of the current connection.

The communication network (or components thereof) is also configurable, according to the infrastructure requirements and/or mobility needs of each client, etc. For example, the communication network (or components thereof) may comprise the capability to support different Layer 2 (L2) or Layer 3 (L3) implementations, or combinations thereof, as well as IPv4/IPv6 traffic.

Understanding user mobility and the demand for transit service is of critical importance for managing transportation systems in medium to large cities. Many transit systems around the world do not provide complete information about the origins and destinations of the users of the transit system. By providing Internet access via, for example, mobile access points (APs) inside buses, coaches, trains, etc., aspects of this disclosure incentivize users to use such transit systems. Furthermore, information from communications sessions conducted between user devices and such APs may provide a clear and complete picture of the mobility of users, transit system usage (e.g., supply and demand), infrastructure needs, etc.

Also, in accordance with various aspects of the present disclosure, information from sensors (e.g., accelerometers, gyroscopes, magnetometers, and/or the like) integrated in mobile APs and/or in the user devices may provide data that may then be analyzed (e.g., in the APs and/or in the Cloud) to detect road and/or vehicle traffic anomalies (e.g., pot holes, accidents, etc.). Furthermore, upon detection of such anomalies, the APs and/or user equipment may automatically capture, for example, various types of event and geolocation information that may be used to provide a quick, accurate, and robust way of alerting the authorities to the necessity of dispatching people and equipment to address road work that may be necessary and/or first responders needed to deal with an accident situation at known locations.

Further, in accordance with various aspects of the present disclosure, the mobile APs and/or user devices may be configured to scan for the presence of, and/or characterize, signals received from third party wireless communication networks. Thus, the operator of a network of moving things may, for example, be able to provide information about the coverage area, usage, outage status, etc. of such third party wireless networks. By seeing that their wireless networks may be used to provide wireless service coverage to the mobile APs of the transit system and therefore the users of the transit system, the operators of a third party wireless networks may then be motivated to reach an agreement with the operator of the mobile APs to provide Internet service top users of the transit system via the mobile APs.

In an example implementation, the capture and analysis of wireless communication session information suitable for performing various aspects of the present disclosure may not depend upon transit system user devices being of any particular make and/or model, may not depend upon the use of any particular operating system (OS) in the user device, and may not depend upon the user device having any particular application(s) installed. In some example implementations, however, user devices may have installed an application provided by an operator of the mobile APs and/or fixed APs of the network of moving things, which may provide additional information useful for performing various aspects of this disclosure. Users may, for example, install such applications in order to obtain access to the network of moving things and/or may be incentivized to install such application in exchange for discounts, enhanced wireless or transit service, etc.

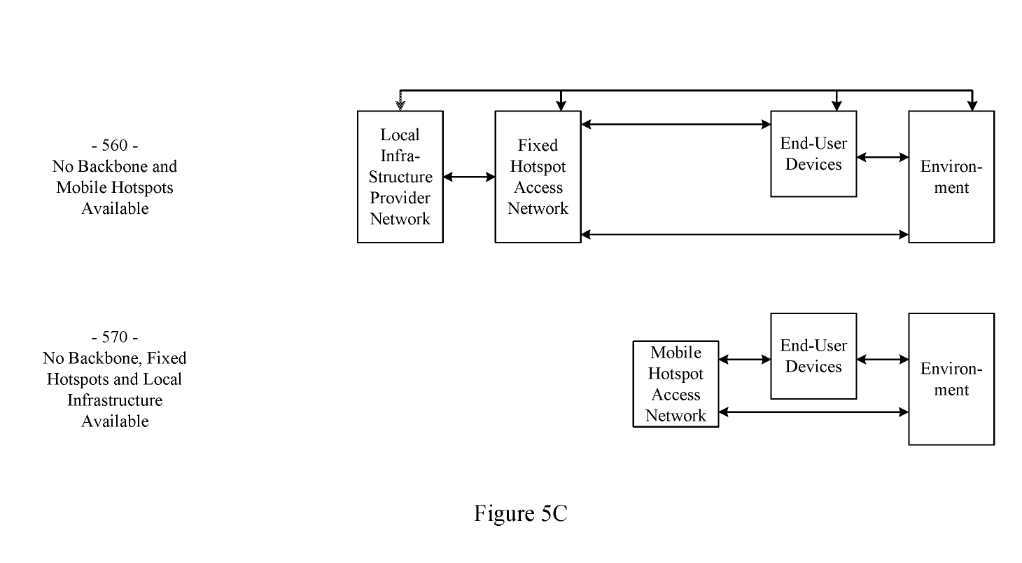

FIG. 7 is a flowchart illustrating an example method of collecting and analyzing data captured by network elements and user devices using a network of moving things to characterize various characteristics of a metropolitan area, in accordance with various aspects of the present invention. The network elements and user devices may correspond to, for example, the fixed and mobile APs of FIGS. 1-6, described above. For example, the fixed APs may be located at various geographic locations within the metropolitan area and may provide wireless connectivity to user devices and the mobile APs, which may be installed in various vehicles (e.g., autonomous vehicles (AVs or UAVs), buses, trains, vans, taxis, trucks, etc.) traveling within the metropolitan area or geographic region, as described with regard to FIGS. 1-6, above. The user devices may be, for example, smart phones; handheld, tablet, or laptop computer, and any other suitable devices having wireless communication interfaces compatible with the fixed and/or mobile APs. Such vehicles may, for example, be equipped with an on-board unit (OBU) with a mobile AP and sensor(s) to measure various characteristics of, for example, the environment (e.g., sensors of atmospheric conditions like heat, humidity, illumination, precipitation; and devices to detect, measure, and receive/demodulate wireless radio frequency signals of wireless networks in the metropolitan area), the movement(s) of the vehicle (e.g., braking, acceleration in multiple axes, vibration), the systems of the vehicle (e.g., sensor and on-board diagnostic interface information about wheel rotation, vehicle speed, application of brakes, various signals and information related to autonomous navigation of a vehicle, etc.)

The process of FIG. 7 begins with block 702 in which various fixed APs, mobile APs, and sensors of the network of moving things are powered up and begin communicating with each other and with user devices. Next, at block 704, the mobile and fixed APs collect and record data from and/or about the user devices as the user devices enter and leave the areas of wireless coverage of the APs. It should be noted that the APs of a network of moving things in accordance with the present disclosure may have multiple wireless interfaces, which may use multiple wireless communication standards (e.g., Wi-Fi (e.g., IEEE 802.11a/b/g/n/ac/af/p), Bluetooth/Bluetooth Low Energy (BLE), IEEE 802.15.4/Zigbee, or other suitable radio frequency wireless communication standards/recommendations). For example, as a user device connects or disconnects from a particular fixed/mobile AP, the fixed/mobile AP may capture and make record of information about the user device such as, for example, the Media Access Control (MAC) address, Bluetooth Device Address, a serial number, or any other information that uniquely identifies the user device; and the current time-of-day and date. The fixed/mobile AP may also include in such a record, information that uniquely identifies the fixed/mobile AP that is connecting/disconnecting from the user device such as, for example, the MAC address and/or serial number of the fixed/mobile AP; receive signal strength information (RSSI) for the signal of the user device received by the fixed/mobile AP, and the geographic location of the fixed/mobile AP at the time of the connection/disconnection. In addition to the examples above, the record of information may include, for example, the amount of data traffic (e.g., incoming and outgoing) for the communication session, the server(s) accessed by the end-user device via the AP (e.g., Facebook® messaging service, Washington Post website, etc.), and information identifying the end-user device and the operating system (OS) in use (e.g., a device type (e.g., smartphone, tablet, etc.) with an OS type (e.g., Android, iOS, Windows). Besides storing information representing the points in time at which the communication session begins and ends (e.g., records indicating that a <device type> running <OS name> accessed server <Y> at location <Z> at time <W>), the AP may also record information about what the end-user did while connected (e.g., information indicating that a <device type> running <OS name> was at AP location <Y> at time <Z> and was/was not accessing the Internet). The AP may also periodically (e.g., every so many seconds/minutes, etc.) store a record of information characterizing each end-user device connected to the AP and its state, such as the example types of information described above. In order to entice users to turn on the wireless networking function of their device (e.g., Wi-Fi (IEEE 802.11a/b/g/n/ac/af/p), BLE, etc.), the operator of the network of moving things may provide Internet access and real-time information such as weather, traffic, transit delays, etc. via the fixed and/or mobile APs.

Next, at block 706, fixed APs may collect data as mobile APs enter and leave fixed AP coverage areas, and connect and disconnect from various fixed APs. For example, as a mobile AP connects or disconnects from a particular fixed AP, the fixed AP may capture and make record of information about the mobile AP such as, for example, the Media Access Control (MAC) address, serial number, an identifier of the vehicle in which the mobile AP is installed, or any other information that uniquely identifies the mobile AP; and the current time-of-day and date. The fixed AP may also include in such a record, information that uniquely identifies the fixed AP from which the mobile AP is connecting/disconnecting such as, for example, the MAC address and/or serial number of the fixed AP; receive signal strength information (RSSI) for the signal of the mobile AP received by the fixed AP, and the geographic location of the mobile AP at the time of the connection/disconnection. In accordance with various aspects of the present disclosure, the geographic location of the fixed AP may be known by the fixed AP and other network elements (e.g., the mobile APs and the Cloud (see FIG. 1)), therefore if an identifier of the fixed AP is available, there is no need to capture and record the geographic location of the fixed AP. Additional information such as, for example, traffic accounting information, start/stop/duration of each communication session, and mobile AP geographic positions (e.g., GNSS/GPS positioning information (e.g., latitude/longitude/altitude)) when connected to a fixed AP (e.g., to enable estimating coverage area of the fixed AP) may be collected for later analysis.

At block 708, sensors integrated with mobile APs, fixed APs, and/or user devices may gather data as people, vehicles, and objects move around the metropolitan area. As described above, the various vehicles in a network of moving things may, for example, be equipped with an on-board unit (OBU) with a mobile AP and various types of sensor(s). Such sensors may measure various characteristics such as, for example, atmospheric conditions like the temperature, humidity, illumination, ionizing radiation/radioactivity, precipitation; wind velocity, and levels of various gases (e.g., oxygen, carbon dioxide, carbon monoxide, oxides of nitrogen, various hydrocarbons, and ozone). The mobile AP/OBU, fixed AP, and/or user device may be configured to detect, measure, and/or demodulate wireless radio frequency signals in various portions of the radio frequency spectrum, including those employed by wireless networks such as, for example, Wi-Fi (e.g., IEEE 802.11a/b/g/n/ac/af/p), Bluetooth®/BLE, IEEE 802.15.4/Zigbee, in the metropolitan area). The OBU/MAP may be configured to capture and record sensors related to the vehicle or operation of the vehicle in which the OBU/MAP is installed. For example, such vehicle related sensors (e.g., accelerometer, magnetometer/magnetic compass, Global Satellite Navigation System (GNSS)/Global Positioning System (GPS) receiver(s)), may capture measurements related to the movement(s) or motion of the vehicle (e.g., braking, acceleration in multiple axes, vibration, tilt, etc.). In addition, the mobile AP/OBU may interface with systems/networks of the vehicle (e.g., sensor and on-board diagnostic interface information about wheel rotation, vehicle speed, application of brakes, and systems for autonomous navigation including, for example laser scanner(s), proximity radar or optical imaging systems used for navigation and collision avoidance, etc.) to enable the OBU to capture information about vehicle operation and navigation. Data from the various data sources discussed above may be captured according to passage of time (e.g., regular or periodic sampling, sampling scheduled for a particular time), according to geographic location (e.g., to be performed at a particular geographic location or within a geographic area), according to a distance traveled (e.g., every X feet/meters/miles/kilometers), and/or according to particular conditions or events (e.g., detection of certain atmospheric, vehicle motion, vehicle navigation, vehicle operation, or wireless radio frequency environment conditions). Sampling of data from the sensors and sources identified above may also be captured according to remote requests (e.g., a neighboring network element (e.g., OBU/MAP, FAP), or a network element in the Cloud).

Then, at block 710, data collected by the fixed APs, mobile APs, sensors, and/or systems is analyzed to extract/extrapolate information about the area traversed. This analysis may take place in the mobile APs, in the fixed APs, in the Cloud, and/or some combination of the three. The analysis may comprise, for example, local processing in user devices and/or APs to summarize the captured/collected information via statistical descriptors that enable communicating the information in a compact way, thus avoiding communicating large amounts of data (independently of the sampling rate of the sensor(s)/systems). These descriptors may then, for example, be sent the Cloud for a possibly more computationally intensive analysis and dissemination. Statistical descriptors in accordance with various aspects of the present disclosure may vary according to the type of data that is used. For example, a statistical descriptor may be as simple as the average speed of a vehicle, or may be a histogram of speed, and may be as complex as, by way of example and not limitation, a scale-invariant feature transform (SIFT)-based descriptor for still images of a camera. Additional information on SIFT may be found, for example, at http://www.scholarpedia.org/article/SIFT. A system in accordance with various aspects of the present disclosure may collect a large database of such descriptors, and may infer anomalies and patterns using, for example, machine learning and/or statistical algorithms. For example, based on speed information of a fleet of vehicles recorded over a period time, a system, after it has been trained, may detect that the speed of vehicles on a particular street is below what is expected/typical (e.g., more than two standard deviations below the average for a given hour of the day), and may trigger a warning to operators or other designated individuals/organizations.

As an example of information that may be gleaned from the data collected via the network of moving things, information about the number of people in any particular place at any particular time(s) may be inferred by the number of people connected to an access point. This information may be used for a variety of purposes such as infrastructure budgeting, public services allocation, network planning, etc. The information may, for example, be made available (e.g., as tables, graphs, and/or the like) via a subscription-based service to public utilities, transit companies, etc. via the Internet (e.g., using a RESTful API).

In accordance with various aspects of the present disclosure, the analysis of the collected data may comprise correlation of data from multiple vehicles in a metropolitan area including, by way of example and not limitation, data collected from human operated and autonomous vehicles such as taxies, buses, trains, vans, and other vehicles. Such collected data from such vehicles may include, for example, sensor and/or vehicle system data indicative of particular road conditions and/or traffic. For example, data collected from vehicle sensors and/or sensor systems such as, for example, GNSS/GPS geolocation data, wheel rotation sensor data, vehicle traction control and/or antilock braking system information, accelerometer data, vehicle radar signals, laser ranging systems, infrared motion/pedestrian sensors, and other sources from one or more vehicles may be analyzed either in the vehicle or at a central system (e.g., the Cloud) to determine whether the collected data is indicative of any notable road conditions. Notable road conditions may include, by way of example and not limitation, accelerometer data characteristic of road defects/road hazards such as rough pavement and/or pot holes; wheel rotation sensor signals or antilock braking or traction control system signals characteristic of slippery pavement due to snow, ice, hydroplaning, and/or road surface contaminants (i.e., oil, dust, dirt, gravel); and/or data that may be representative of unusual vehicle movements (e.g., accelerometer or other sensor/vehicle system data characteristic of vehicle skidding, swerving, fishtailing, and/or braking) that have occurred. The analysis of collected data may comprise determining whether the origin of data indicating any notable road conditions and/or unusual vehicle events occurred at or near the same point in time (e.g., local time, GNSS/GPS time, and/or GMT) and determining whether data indicative of the same/similar notable road conditions and/or unusual vehicle events was collected from one or more other vehicles at geographic locations near one another (e.g., determined using radio frequency vehicle-to-vehicle or vehicle to infrastructure (e.g., vehicle OBU/MAP to FAP) ranging information or GNSS positioning information) to be in the vicinity of one another or on a common vehicle route. Such determinations may be indicative of a common road condition and/or threat to vehicle travel on that vehicle route. Such a determination may be made by one or more vehicles, working together or alone, or by a centralized, Cloud-based system that receives the data collected from the vehicles of, for example, the metropolitan area. The determination of existence of notable road conditions and/or unusual vehicle movements/events in a particular geographic location (e.g., a particular portion of a road) over a period of time (e.g., seconds, minutes, hours, days) by different vehicles may be indicative of a stationary road hazard. Once such notable road conditions and unusual vehicle movements/events are identified by the analysis as described herein, information about such road conditions and vehicle events may be sent to systems of vehicles in the metropolitan area or region in which the notable road conditions and/or unusual vehicle movements/events have been determined to exist. Those vehicle systems, upon receiving such information, may inform a human operator to enable the human operator to take such information into account, or may autonomously adjust the navigation of an autonomously driven vehicle through or around the affected roads or areas.

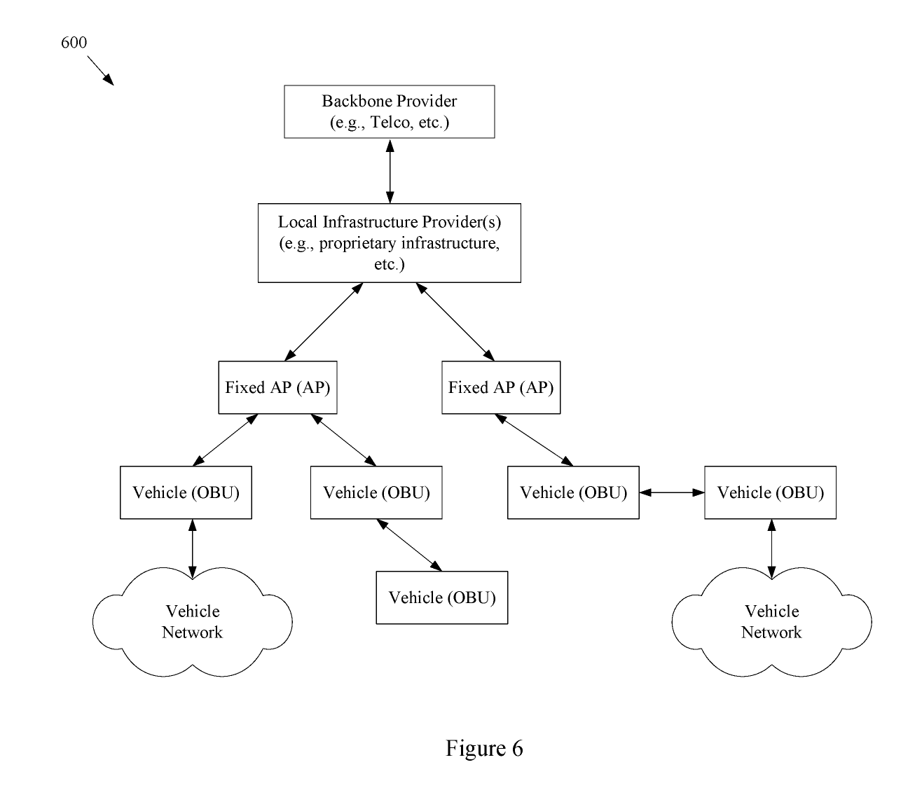

In an example implementation, various kinds of data collected by fixed and/or mobile APs, and/or user devices may be correlated with other sources of information such as weather data, air pollution data, traffic reports, etc., Samples of the data may be correlated using many possible types of correlation including, by way of example and not limitation, association rule learning or similar techniques, and statistical correlation. Additional information about association rule learning may, for example, be found at https://en.wikipedia.org/wiki/Association_rule_learning, while additional information about statistical correlation may, for example, be found at https://en.wikipedia.org/wiki/Correlation_and_dependence. In accordance with various aspects of the present disclosure, a system as described herein may be used to gather information such as, for example, sensor measurements of carbon monoxide/hydrocarbons/oxides of nitrogen (or other gases/pollutants) collected by vehicles connected via a network of moving things, to modulate vehicle admittance or cost of vehicle licenses to enter a particular area of a city, region, or country, and/or may gather temperature information that enables the detection of urban heat islands by relating temperature sensor data with the geographic location at which the temperature data was captured. Correlations between a number of people in a region and the weather of the region may be used to help predict the number of people expected to use a public transit system (e.g., the bus), or passing by a particular street equipped with a fixed AP, thereby enabling predictions of public transit and data infrastructure loading. Other examples of such information about a particular geographic area that may be collected via a network of moving things are described below with reference to FIGS. 8-10.

FIG. 8 is a flowchart illustrating an example method of collecting and analyzing data via a network of moving things to discover information about users of a transit system, in accordance with various aspects of the present invention. As in the example of FIG. 7, the network elements and user devices may correspond to, for example, the network elements of FIGS. 1-6, described above. For example, fixed APs may be located at various fixed/stationary geographic locations within the metropolitan area and may provide wireless connectivity to user devices and mobile APs, which may be installed in various vehicles (e.g., human operated and/or autonomous vehicles, buses, trains, vans, taxis, trucks, etc.) traveling within the metropolitan area, as described with regard to FIGS. 1-6, above. The user devices may be, for example, smart phones; handheld, tablet, or laptop computers; and any other suitable devices having wireless communication interfaces compatible with the fixed and/or mobile APs. Such vehicles may, for example, be equipped with an on-board unit (OBU) having a mobile AP and sensor(s) to measure various characteristics.

At block 802, a user device may enter a coverage area of an AP of the network of moving things and a communication session between the user device and AP may begin. Such a communication session may employ any suitable radio frequency communication standards or recommendations, such as those described herein, and may or may not involve/require actions by the end-user of the user device. For example, the entry within the coverage area of the AP of the end-user with the operating user device may cause the user device to engage in radio frequency communication with the AP (e.g., a Wi-Fi or BLE interface of the user device “associating” or receiving and/or sending signals from/to the communication circuitry of the AP).

Next, at block 804, information such as user device identifiers (e.g., MAC address, Bluetooth Device Address, IMEI, telephone number), current AP geographic location (e.g., GNSS/GPS positioning information), date, and time of the start of the communication session may be logged by the AP. Such logged information may be immediately sent to a remote system (e.g., a Cloud-base system), or may be maintained at the AP until a later time.

Then, at block 806, the communication session may be terminated when the user device of the end-user leaves the coverage area of the AP with which the communication session began.

At block 808, information such as user device identifiers, geographic location, date, and time of the end of the communication session may be logged. Depending upon the nature of the AP (e.g., fixed or mobile), the AP may log information such as the current AP geographic location (e.g., GNSS/GPS positioning information), date, and time of the end of the communication session with the user device. Such logged information may be immediately sent to a remote system (e.g., a Cloud-base system), with or after the information logged at the start of the communication session, or may be maintained at the AP in association with the information from the start of the communication session, until a later time.

Next, at block 810, the communication session information logged by the AP (i.e., the AP with which the user device engaged in a communication session) may be processed, to analyze/characterize transit/infrastructure/etc. usage patterns etc. For example, information about the number of passengers on a vehicle (e.g., human operated or autonomous taxi, bus, train, van, etc.) and their respective origins and destinations may be derived from the collected communication session data. In accordance with various aspects of the present disclosure, an estimate of the number of transit riders on a vehicle may be extrapolated from the number of active communication sessions using statistical information that identifies the percentage of transit riders on the bus that typically carry a user device and permit it to connect to the mobile APs. This information may be of value to many transportation service providers that only validate tickets when passengers enter the transit vehicle, and do not track the passengers that exit the transit vehicle. Such information may be extremely useful when autonomous vehicles are used, to automatically track trips of transit passengers on vehicles without a driver to monitor ticketholders. Such information may also be useful for route planning, staffing, infrastructure budgeting, etc.

In accordance with various aspects of the present disclosure, user communication session information log entries may be used to produce passenger flows that may be analyzed and automatically summarized numerically into Origin-Destination tables and graphs, and that may be summarized visually using graph bundling algorithms. In accordance with some aspects of the present disclosure, the user communication session information may be filtered based on a variety of factors in order to improve the results of the analysis. For example, short user communication sessions (e.g., in terms of distance or time), which may result when, for example, a device located in a vehicle that stops temporarily next to a mobile AP equipped bus at a stop light establishes a communication session with the mobile AP of the bus. Such short communication sessions may be filtered out/discarded from data for user communication sessions, based on the physical distance traveled and/or length of time during which the communication session exists, as such communication sessions may not be related to the mobility of users using the transit system. In accordance with various aspects of the present disclosure, multi-leg (e.g., commutes having two or more hops, legs, or segments and one or more transfers between hops, legs, or segments via different vehicles (e.g., taxis, buses, trains, vans, etc.)) commutes may be identified by identifying user communication sessions with the same user device identifier (e.g., MAC address, Bluetooth Device Address, IMEI, IMSI, telephone number, etc.) within a determined time frame and distance proximity.

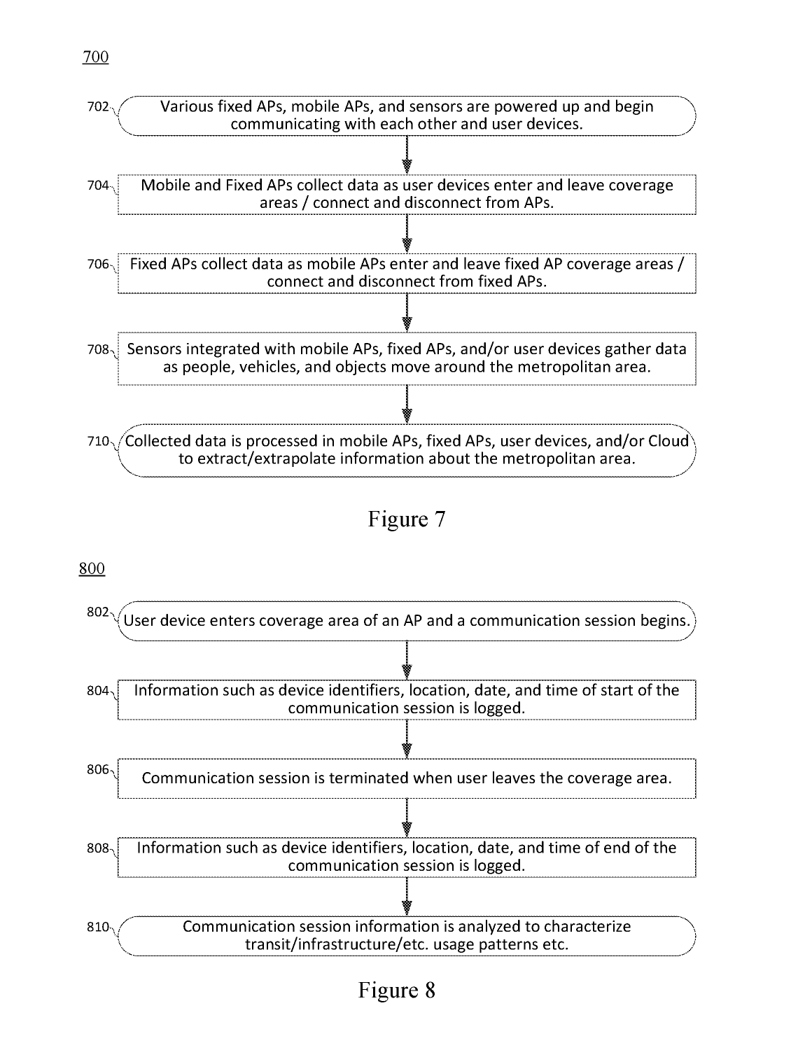

FIG. 9 is a flowchart illustrating an example method of collecting and analyzing data via a network of moving things to discover the condition of a metropolitan area infrastructure, in accordance with various aspects of the present invention. As in the examples of FIGS. 7 and 8, above, the network elements and user devices may correspond to, for example, the network elements of FIGS. 1-6, described above. For example, mobile APs may be installed in various vehicles (e.g., human operated and/or autonomous vehicles, buses, trains, vans, taxis, trucks, etc.) that travel through and among various geographic locations within the metropolitan area and may provide wireless connectivity to sensors, user devices, and other mobile APs. The user devices may be, for example, smart phones; handheld, tablet, or laptop computers; and any other suitable devices having wireless communication interfaces compatible with the fixed and/or mobile APs. Such vehicles may, for example, be equipped with an on-board unit (OBU) having a mobile AP and sensor(s) to measure various characteristics or conditions of the roads, streets, and highways in the metropolitan area.

The method of FIG. 9 begins at block 902, where sensors and mobile AP of a vehicle are powered on and begin generating readings/output. As discussed above, sensors and mobile APs may be configured to measure and record/log various characteristics of, for example, the environment (e.g., sensors of atmospheric conditions like heat, humidity, illumination, precipitation; and devices to detect, measure, and receive/demodulate wireless radio frequency signals of various third party wireless (e.g., radio frequency) signals and networks in the metropolitan area). As previous discussed, the sensor(s) and mobile APs may also be configured to measure and record/log the movement(s) of the vehicle (e.g., braking, acceleration in multiple axes, vibration), and data from various systems of the vehicle (e.g., sensor and on-board diagnostic interface information about wheel rotation, vehicle speed, application of brakes, various signals and information related to autonomous navigation of a vehicle, etc.). Such collected information may be analyzed at the OBU, or stored for later transmission to a centralized system (e.g., in the Cloud) for storage and/or analysis there.

At block 904 of FIG. 9, the readings/outputs generated by the sensors are captured as the vehicles on which the sensors reside move about. In the case of sensors on user devices, a software application present on the user device(s) may collect the sensor data (e.g., accelerometer, gyroscope, magnetometer, GNSS/GPS data, and signals received from third party wireless (e.g., radio frequency) networks for which the user device is equipped) and periodically and/or occasionally send it to a mobile AP or fixed AP within range of the user device. In the case of sensors residing on mobile APs, those mobile APs may collect the sensor data and periodically and/or occasionally send it to a fixed AP that is within range of the wireless interface(s) of the mobile AP.

Next, at block 906, the sensor data collected from various sources may be aggregated and analyzed (e.g., in a mobile AP, a fixed AP, the Cloud, or any combination thereof) to determine the condition of the transportation infrastructure such as potholes in roads, areas of heavy traffic, geographic locations of accidents, hazardous weather-related conditions (e.g., heavy rain, ice, snow, water on pavement, etc.). The analysis may, for example, take place in the mobile AP, using information provided by neighboring mobile APs of nearby vehicles or fixed APs, or may be produced by other network elements (e.g., a system in the Cloud) and transmitted to mobile APs in the metropolitan area. Such local (i.e., at the mobile AP) and/or centralized (i.e., in the Cloud or other network element) analysis may take advantage of machine learning algorithms that learn signatures of road anomalies using the sensor data collected from vehicles in the metropolitan area, and/or from network elements of other metropolitan areas, and thus are able to detect various anomalies representative of notable road conditions or unusual traffic events of which drivers/operators of human operated vehicles, and autonomous vehicle navigation system, may be made aware. The analysis may comprise voting systems and/or the like for combining/reconciling data for the same location but from different sources and/or different times.

For example, a number of different human operated or autonomous vehicles may report a notable road condition (e.g., one generating accelerometer outputs in one or more axes above respective thresholds and/or having particular frequency components) at various times, at a particular portion (i.e., geographic location) of a road, and such collected sensor data may be analyzed and may be found to match a signature/pattern that characterizes, for example, a pothole. Such information may be used to notify nearby/approaching vehicle systems of the hazard, to enable those vehicle operators or autonomous navigation systems to, for example, change to a different lane of the road, or change sensors and parameters used by algorithms used in, e.g., video or infrared imaging and/or laser scanning of road surfaces used for object detection and avoidance, to more accurately detect and steer around the hazard.

In another example in accordance with aspects of the present disclosure, one or more mobile APs may report data collected from systems of their respective vehicles (e.g., antilock braking systems and traction control system or their components), which may be analyzed, and found to match a signature/pattern that characterizes, for example, a loss of vehicle traction at a particular portion/geographic location of a road. Based on such information, the system performing such analysis may notify operators of the vehicles and/or the autonomous vehicle navigation systems of the vehicles of the notable road condition, to enable operators and autonomous vehicles in or approaching the affected road portion or location to adjust their travel route or the operation of the systems of the notified vehicles, to help to avoid (e.g., by changing the route taken) or to more safely or effectively react to (e.g., adjust suspension, traction control, or antilock braking system parameters and/or behavior) the notable road condition.

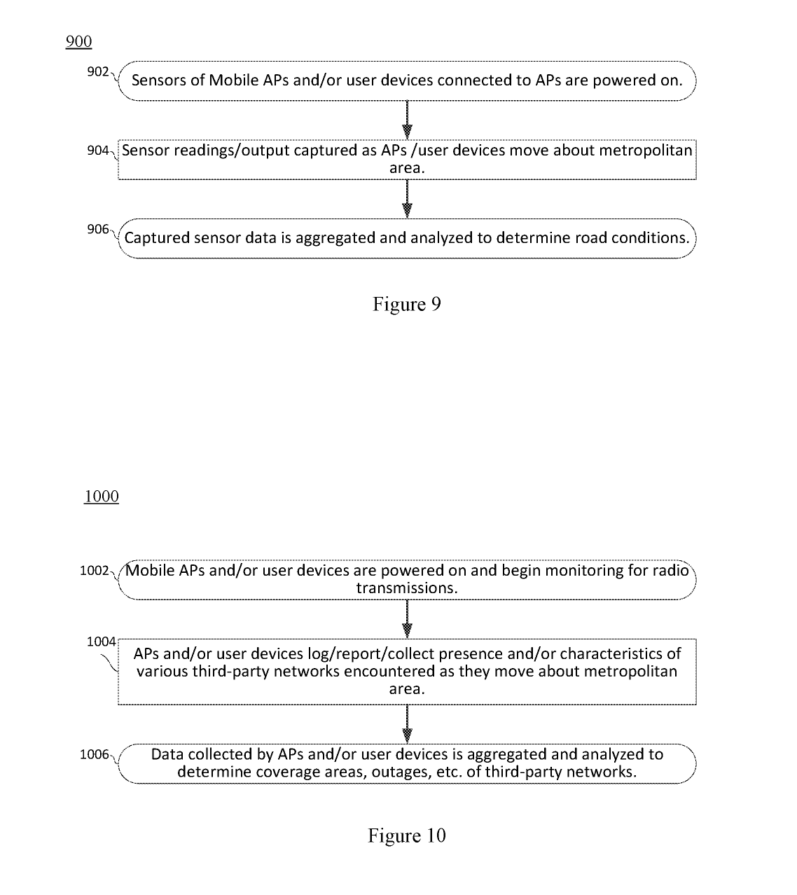

FIG. 10 is a flowchart illustrating an example method of collecting and analyzing data via a network of moving things to characterize third party networks, in accordance with various aspects of the present invention. As discussed above in the examples of FIGS. 7 to 9, the network elements and user devices may, for example, correspond to the network elements of FIGS. 1-6, described above. In such example networks, mobile APs may be installed in various vehicles (e.g., human operated and/or autonomous vehicles, buses, trains, vans, taxis, trucks, etc.) that travel through and among various geographic locations within the metropolitan area and may provide wireless connectivity to sensors, user devices, and other mobile APs. The user devices may be, for example, smart phones; handheld, tablet, or laptop computers; and any other suitable devices having wireless communication interfaces compatible with the fixed and/or mobile APs. Such vehicles may, for example, be equipped with an on-board unit (OBU) having a mobile AP and sensor(s) to receive, measure, and demodulate various radio frequency signals of third party networks and sources in the metropolitan area.

At block 1002, a mobile AP and/or user devices are powered on and begin monitoring for radio transmissions of radio frequency sources and third party networks. As discussed above, sensors and mobile APs may be configured to measure and record/log various characteristics of, for example, the environment (e.g., sensors of atmospheric conditions like heat, humidity, illumination, precipitation; and devices to detect, measure, and receive/demodulate wireless radio frequency signals of various third party wireless (e.g., radio frequency) signals and networks in the metropolitan area). As previous discussed, the sensor(s) and mobile APs may also be configured to measure and record/log the geographic location and movement(s) of the vehicle (e.g., GNSS/GPS positioning information, vehicle braking, vehicle accelerations in multiple axes, vehicle and/or wheel vibration), and data from various systems of the vehicle (e.g., sensor and on-board diagnostic interface information about wheel rotation, vehicle speed, application of brakes, various signals and information related to autonomous navigation of a vehicle, etc.). Receivers used to monitor radio frequency signals and third party networks may comprise software-defined radios that may be configured to operate over portions of a large range of frequencies of the RF spectrum (e.g., 50 MHz to 1.9 GHZ) and be capable of providing an indication of signal frequency, bandwidth, an indication of receive signal strength, type(s) of modulation, and other information. The receiver(s) may be locally and/or remotely provisionable with particular private or third party network-specific parameters (e.g., provided by the operators of the third party network(s)), to permit the receiver(s) to be configured to accurately and efficiently demodulate and decode particular third party network signals (e.g., access, paging, pilot, timing, traffic, broadcast, etc. channels), and to collect information from and about such radio frequency signals of third party networks. Such collected information may be analyzed at the OBU, or stored for later transmission to a centralized system (e.g., in the Cloud) for storage and/or analysis there.

Next, at block 1004, the mobile APs and/or user devices may log/report presence and/or characteristics (e.g., signal strength, connection quality, level of activity/congestion on the network, etc.) of various third-party networks (e.g., Wi-Fi, cellular (e.g., UMTS, 4G LTE), etc.) encountered as they move about the metropolitan area. In the case of receives/sensors on user devices, a software application present on the user devices may collect the receiver/sensor network data and may periodically and/or occasionally send it to a mobile AP, fixed AP, or Cloud-based system.

Then, at block 1006, the data collected by the APs and/or user devices may be aggregated and analyzed (e.g., in a mobile AP, a fixed AP, the Cloud, or any combination thereof) to determine coverage areas, outages, etc. of the third-party networks detected in the metropolitan area. The analysis of such data collected about radio frequency signals and third party networks may, for example, be used to direct the navigation of autonomous vehicles to automatically travel certain routes within the metropolitan area, to more accurately characterize the coverage area of particular third party networks found to have areas of coverage with below-acceptable signal quality and therefore a poor expected end-user experience.

For example, during the travels of human-operated or autonomously navigated vehicles, the OBUs of such vehicles or linked user devices may receive and report data representative of received signals in regions of the metropolitan area. Analysis of such data (e.g., in the mobile APs or the Cloud) may indicate that the signal quality, user capacity, and/or other network performance characteristics of one or more portions of the coverage areas of one or more particular third party networks are less than a defined threshold, and/or provide less than a particular desired Quality of Experience (QoE) or Quality of Service (QoS). In response, a system in accordance with aspects of the present disclosure may provide navigation information to one or more autonomously navigated vehicle(s), to direct such vehicles to travel specific routes to enable the receivers/sensors of the OBU of such autonomously navigated vehicles to make additional and more complete assessments of the signal characteristics of the third party network in the portions exhibiting the signal quality, user capacity, and/or other network performance characteristics less than the defined threshold or that are expected to result in a less than desirable end-user QoE or QoS. Information acquired by the autonomously navigated vehicles traveling the specific routes determined using the collected third party network coverage information enables the more rapid, more accurate, and more complete definition of the third party network coverage area, and permits the third party network operator to more efficiently make corrective adjustments.

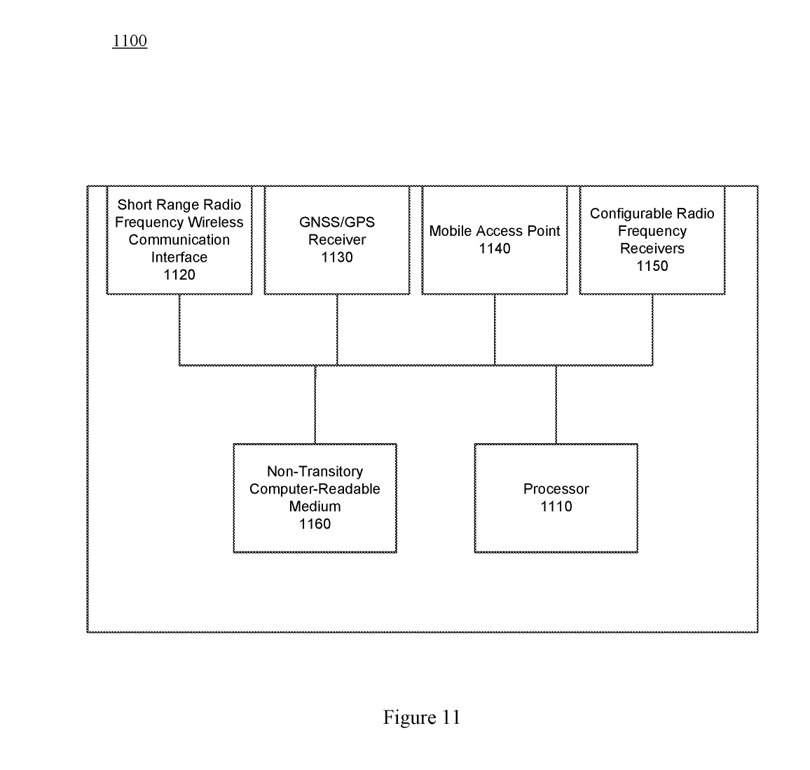

FIG. 11 is a block diagram of an example on-board unit (OBU), in accordance with various aspects of the present disclosure. The OBU 1100 of FIG. 11 may correspond to, for example, the OBU of FIG. 6, or corresponding network elements of any other of FIGS. 1-5. The illustration of FIG. 11 includes a processor 1110, which may, for example, comprise one or more processors in a single package/housing or in multiple packages/housings located together or distributed, and which may access instructions executable by the processor 1110 stored in a non-transitory storage medium (e.g., flash storage, EPROM, EEPROM, ROM, battery backed RAM, or any other suitable non-transitory storage technology). Addition storage/memory (not shown) may also be provided as part of the OBU 1100. In addition, the OBU of FIG. 1100 includes a radio frequency (RF) wireless communication interface 1120 that may be, for example, a short-range wireless communication interface operating according to communication protocol such as a Direct Short Range Communication (DSRC) standard. The OBU 1100 also includes a Global Satellite Navigation System (GNSS) receiver 1130, which may receive and process radio frequency geolocation signals compatible with any or all of the Global Positioning System (GPS), Glonass, etc. satellite-based navigation systems. The OBU 1100 of FIG. 11 also includes a mobile access point (MAP) that may wirelessly communicate with other electronic devices such as, for example, smart phones; handheld, tablet, and laptop computers, and other devices using, for example, IEEE 802.11a/b/g/n/ac/af/p, Bluetooth or Bluetooth Low Energy (BLE), IEEE 802.15.4/Zigbee, or other wireless air interface standards. The OBU 1100 also includes one or more RF receivers 1150 that may be configurable via hardware and/or software to detect, measures, receive, and demodulate various portions of a wide range of RF spectrum including radio frequency signals present in metropolitan areas such as, for example, broadcast radio and television signals, cellular telephone and infrastructure radio frequency signals, Wi-Fi (e.g., IEEE-802.11a/b/g/n/ac/af/p). Although not shown, the OBU 1100 of FIG. 11 may also include one or more suitable interfaces to communicate with vehicle buses such as On-Board Diagnostics (OBD)/(OBD-II), Controller Area Network (CAN) bus, or other suitable vehicle system electrical interfaces. It should be noted that, although many of the elements of FIG. 11 have additional components that may be present for their use (e.g., antennas, power supplies/battery backups, etc.), those additional elements have been omitted for reasons of clarity.

Various aspects of the present disclosure may be seen in a method of optimizing performance of one or more third party wireless networks over a service area using a plurality of vehicles of a network of moving things, where each vehicle comprises an on-board unit. The on-board unit may comprise a radio frequency interface supporting wireless communication with other vehicles of the plurality of vehicles, a global navigation satellite system (GNSS) receiver, a mobile access point for providing wireless access to end-user devices, and one or more radio frequency receivers. Each radio frequency receiver of the one or more radio frequency receivers may be configurable to receive signals of a respective third party network of the one or more third party networks. Such a method may comprise applying power to the on-board unit of a first vehicle to enable reception, by the corresponding one or more radio frequency receivers, of signals of the respective third party network; and collecting data representative of the signals of the one or more third party networks received by the corresponding one or more radio frequency receivers and corresponding geographic location information, during movement of the corresponding vehicle over the service area. The method may also comprise analyzing the collected data and the corresponding geographic location information to determine characteristics of wireless coverage of the one or more third party networks over the service area. The method may further comprise transmitting new travel route information, to the on-board unit of the corresponding vehicle, for navigating movement of the corresponding vehicle over the service area according to the analysis of the collected data representative of the signals and the corresponding geographic location information.

In accordance with various aspects of the present disclosure, the one or more third party networks may comprise a wireless network that communicates using a cellular network radio interface protocol standard, and the one or more third party networks may comprise a wireless network that communicates using a commercial broadcast radio frequency interface protocol standard. The first vehicle may be an autonomously navigated vehicle for operation on public roads. Applying power to the on-board unit of a first vehicle may comprises provisioning the one or more radio frequency receivers to operate on the respective third party networks. The method may further comprise receiving, from an on-board unit of a second vehicle, data representative of the signals of the one or more third party networks and corresponding geographic location information collected by the second vehicle during movement of the second vehicle over the service area; and analyzing the data collected at the first vehicle and the second vehicle and the corresponding geographic location information to determine characteristics of wireless coverage of the one or more third party networks over the service area. The mobile access point may provide end-user wireless Internet access to occupants of the first vehicle, and the data representative of the signals of the one or more third party networks may be predictive of a quality of experience of end-users of the one or more third party networks. The method may further comprise transmitting results of the analysis for a particular third party network of the one or more third party networks to a cloud-based system, the cloud-based system generating one or more web pages representative of wireless service coverage of the particular third party network.

Additional aspects of the present disclosure may be seen in a non-transitory computer-readable medium having stored thereon, a computer program having at least one code section. The at least one code section may be executable by one or more processors for causing the one or more processors to perform operations of a method for optimizing performance of one or more third party wireless networks over a service area using a plurality of vehicles of a network of moving things. Each vehicle may comprise an on-board unit comprising a radio frequency interface supporting wireless communication with other vehicles of the plurality of vehicles, a global navigation satellite system (GNSS) receiver, a mobile access point for providing wireless access to end-user devices, and one or more radio frequency receivers. Each radio frequency receiver of the one or more radio frequency receivers may be configurable to receive signals of a respective third party network of the one or more third party networks. Such a method may perform steps of the method described above.

Further aspects of the present disclosure may be seen in a system for optimizing performance of one or more third party wireless networks over a service area using a plurality of vehicles of a network of moving things. In such a system, each vehicle may comprise an on-board unit comprising a radio frequency interface supporting wireless communication with other vehicles of the plurality of vehicles; a global navigation satellite system (GNSS) receiver; a mobile access point for providing wireless access to end-user devices; one or more radio frequency receivers, each radio frequency receiver of the one or more radio frequency receivers configurable to receive signals of a respective third party network of the one or more third party networks; one or more processors for communicatively coupling to the radio frequency interface, the GNSS receiver, the mobile access point, and the one or more processors. The one or more processors may be operable to, at least, perform the steps of the method described above.

In accordance with various aspects of this disclosure, examples of the networks and/or components thereof presented herein are provided in U.S. Provisional Application Ser. No. 62/222,192, titled “Communication Network of Moving Things,” filed on Sep. 22, 2015, which is hereby incorporated herein by reference in its entirety.

In accordance with various aspects of this disclosure, the networks and/or components thereof presented herein are provided with systems and methods for integrating such networks and/or components with other networks and systems, non-limiting examples of which are provided in U.S. Provisional Application Ser. No. 62/221,997, titled “Integrated Communication Network for A Network of Moving Things,” filed on Sep. 22, 2015, which is hereby incorporated herein by reference in its entirety.

Also, in accordance with various aspects of this disclosure, the networks and/or components thereof presented herein are provided with systems and methods for synchronizing such networks and/or components, non-limiting examples of which are provided in U.S. Provisional Application Ser. No. 62/222,016, titled “Systems and Methods for Synchronizing a Network of Moving Things,” filed on Sep. 22, 2015, which is hereby incorporated herein by reference in its entirety.

Additionally, in accordance with various aspects of this disclosure, the networks and/or components thereof presented herein are provided with systems and methods for managing such networks and/or components, non-limiting examples of which are provided in U.S. Provisional Application Ser. No. 62/222,042, titled “Systems and Methods for Managing a Network of Moving Things,” filed on Sep. 22, 2015, which is hereby incorporated herein by reference in its entirety.

Further, in accordance with various aspects of this disclosure, the networks and/or components thereof presented herein are provided with systems and methods for monitoring such networks and/or components, non-limiting examples of which are provided in U.S. Provisional Application Ser. No. 62/222,066, titled “Systems and Methods for Monitoring a Network of Moving Things,” filed on Sep. 22, 2015, which is hereby incorporated herein by reference in its entirety.

Still further, in accordance with various aspects of this disclosure, the networks and/or components thereof presented herein are provided with systems and methods for detecting and/or classifying anomalies in such networks and/or components, non-limiting examples of which are provided in U.S. Provisional Application Ser. No. 62/222,077, titled “Systems and Methods for Detecting and Classifying Anomalies in a Network of Moving Things,” filed on Sep. 22, 2015, which is hereby incorporated herein by reference in its entirety.

Yet further, in accordance with various aspects of this disclosure, the networks and/or components thereof presented herein are provided with systems and methods for managing mobility in such networks and/or components, non-limiting examples of which are provided in U.S. Provisional Application Ser. No. 62/222,098, titled “Systems and Methods for Managing Mobility in a Network of Moving Things,” filed on Sep. 22, 2015, which is hereby incorporated herein by reference in its entirety.

Also, in accordance with various aspects of this disclosure, the networks and/or components thereof presented herein are provided with systems and methods for managing connectivity in such networks and/or components, non-limiting examples of which are provided in U.S. Provisional Application Ser. No. 62/222,121, titled “Systems and Methods for Managing Connectivity a Network of Moving Things,” filed on Sep. 22, 2015, which is hereby incorporated herein by reference in its entirety.

Additionally, in accordance with various aspects of this disclosure, the networks and/or components thereof presented herein are provided with systems and methods for collecting sensor data in such networks and/or components, non-limiting examples of which are provided in U.S. Provisional Application Ser. No. 62/222,135, titled “Systems and Methods for Collecting Sensor Data in a Network of Moving Things,” filed on Sep. 22, 2015, which is hereby incorporated herein by reference in its entirety.

Further, in accordance with various aspects of this disclosure, the networks and/or components thereof presented herein are provided with systems and methods for interfacing with such networks and/or components, non-limiting examples of which are provided in U.S. Provisional Application Ser. No. 62/222,145, titled “Systems and Methods for Interfacing with a Network of Moving Things,” filed on Sep. 22, 2015, which is hereby incorporated herein by reference in its entirety.

Still further, in accordance with various aspects of this disclosure, the networks and/or components thereof presented herein are provided with systems and methods for interfacing with a user of such networks and/or components, non-limiting examples of which are provided in U.S. Provisional Application Ser. No. 62/222,150, titled “Systems and Methods for Interfacing with a User of a Network of Moving Things,” filed on Sep. 22, 2015, which is hereby incorporated herein by reference in its entirety.

Yet further, in accordance with various aspects of this disclosure, the networks and/or components thereof presented herein are provided with systems and methods for data storage and processing in such networks and/or components, non-limiting examples of which are provided in U.S. Provisional Application Ser. No. 62/222,168, titled “Systems and Methods for Data Storage and Processing for a Network of Moving Things,” filed on Sep. 22, 2015, which is hereby incorporated herein by reference in its entirety.

Also, in accordance with various aspects of this disclosure, the networks and/or components thereof presented herein are provided with systems and methods for vehicle traffic management in such networks and/or components, non-limiting examples of which are provided in U.S. Provisional Application Ser. No. 62/222,183, titled “Systems and Methods for Vehicle Traffic Management in a Network of Moving Things,” filed on Sep. 22, 2015, which is hereby incorporated herein by reference in its entirety.

Additionally, in accordance with various aspects of this disclosure, the networks and/or components thereof presented herein are provided with systems and methods for environmental management in such networks and/or components, non-limiting examples of which are provided in U.S. Provisional Application Ser. No. 62/222,186, titled “Systems and Methods for Environmental Management in a Network of Moving Things,” filed on Sep. 22, 2015, which is hereby incorporated herein by reference in its entirety.

Further, in accordance with various aspects of this disclosure, the networks and/or components thereof presented herein are provided with systems and methods for managing port or shipping operation in such networks and/or components, non-limiting examples of which are provided in U.S. Provisional Application Ser. No. 62/222,190, titled “Systems and Methods for Port Management in a Network of Moving Things,” filed on Sep. 22, 2015, which is hereby incorporated herein by reference in its entirety.

Also, in accordance with various aspects of this disclosure, the networks and/or components thereof presented herein are provided with systems and methods for enhancing the accuracy of positioning or location information based at least in part on historical data, non-limiting examples of which are provided in U.S. Provisional Application Ser. No. 62/244,828, titled “Utilizing Historical Data to Correct GPS Data in a Network of Moving Things,” filed on Oct. 22, 2015, which is hereby incorporated herein by reference in its entirety.

Additionally, in accordance with various aspects of this disclosure, the networks and/or components thereof presented herein are provided with systems and methods for enhancing the accuracy of position or location of positioning or location information based at least in part on the utilization of anchors, non-limiting examples of which are provided in U.S. Provisional Application Ser. No. 62/244,930, titled “Using Anchors to Correct GPS Data in a Network of Moving Things,” filed on Oct. 22, 2015, which is hereby incorporated herein by reference in its entirety.

Further, in accordance with various aspects of this disclosure, the networks and/or components thereof presented herein are provided with systems and methods for providing communication between applications, non-limiting examples of which are provided in U.S. Provisional Application Ser. No. 62/246,368, titled “Systems and Methods for Inter-Application Communication in a Network of Moving Things,” filed on Oct. 26, 2015, which is hereby incorporated herein by reference in its entirety.

Still further, in accordance with various aspects of this disclosure, the networks and/or components thereof presented herein are provided with systems and methods for probing, analyzing and/or validating communication, non-limiting examples of which are provided in U.S. Provisional Application Ser. No. 62/246,372, titled “Systems and Methods for Probing and Validating Communication in a Network of Moving Things,” filed on Oct. 26, 2015, which is hereby incorporated herein by reference in its entirety.

Yet further, in accordance with various aspects of this disclosure, the networks and/or components thereof presented herein are provided with systems and methods for adapting communication rate, non-limiting examples of which are provided in U.S. Provisional Application Ser. No. 62/250,544, titled “Adaptive Rate Control for Vehicular Networks,” filed on Nov. 4, 2015, which is hereby incorporated herein by reference in its entirety.

Also, in accordance with various aspects of this disclosure, the networks and/or components thereof presented herein are provided with systems and methods for reconfiguring and adapting hardware, non-limiting examples of which are provided in U.S. Provisional Application Ser. No. 62/273,878, titled “Systems and Methods for Reconfiguring and Adapting Hardware in a Network of Moving Things,” filed on Dec. 31, 2015, which is hereby incorporated herein by reference in its entirety.

Additionally, in accordance with various aspects of this disclosure, the networks and/or components thereof presented herein are provided with systems and methods for optimizing the gathering of data, non-limiting examples of which are provided in U.S. Provisional Application Ser. No. 62/253,249, titled “Systems and Methods for Optimizing Data Gathering in a Network of Moving Things,” filed on Nov. 10, 2015, which is hereby incorporated herein by reference in its entirety.

Further, in accordance with various aspects of this disclosure, the networks and/or components thereof presented herein are provided with systems and methods for performing delay tolerant networking, non-limiting examples of which are provided in U.S. Provisional Application Ser. No. 62/257,421, titled “Systems and Methods for Delay Tolerant Networking in a Network of Moving Things,” filed on Nov. 19, 2015, which is hereby incorporated herein by reference in its entirety.

Still further, in accordance with various aspects of this disclosure, the networks and/or components thereof presented herein are provided with systems and methods for improving the coverage and throughput of mobile access points, non-limiting examples of which are provided in U.S. Provisional Application Ser. No. 62/265,267, titled “Systems and Methods for Improving Coverage and Throughput of Mobile Access Points in a Network of Moving Things,” filed on Dec. 9, 2015, which is hereby incorporated herein by reference in its entirety.

Yet further, in accordance with various aspects of this disclosure, the networks and/or components thereof presented herein are provided with systems and methods for coordinating channel utilization, non-limiting examples of which are provided in U.S. Provisional Application Ser. No. 62/270,858, titled “Channel Coordination in a Network of Moving Things,” filed on Dec. 22, 2015, which is hereby incorporated herein by reference in its entirety.

Also, in accordance with various aspects of this disclosure, the networks and/or components thereof presented herein are provided with systems and methods for implementing a network coded mesh network in the network of moving things, non-limiting examples of which are provided in U.S. Provisional Application Ser. No. 62/257,854, titled “Systems and Methods for Network Coded Mesh Networking in a Network of Moving Things,” filed on Nov. 20, 2015, which is hereby incorporated herein by reference in its entirety.

Additionally, in accordance with various aspects of this disclosure, the networks and/or components thereof presented herein are provided with systems and methods for improving the coverage of fixed access points, non-limiting examples of which are provided in U.S. Provisional Application Ser. No. 62/260,749, titled “Systems and Methods for Improving Fixed Access Point Coverage in a Network of Moving Things,” filed on Nov. 30, 2015, which is hereby incorporated herein by reference in its entirety.

Further, in accordance with various aspects of this disclosure, the networks and/or components thereof presented herein are provided with systems and methods for managing mobility controllers and their network interactions, non-limiting examples of which are provided in U.S. Provisional Application Ser. No. 62/273,715, titled “Systems and Methods for Managing Mobility Controllers and Their Network Interactions in a Network of Moving Things,” filed on Dec. 31, 2015, which is hereby incorporated herein by reference in its entirety.

Still further, in accordance with various aspects of this disclosure, the networks and/or components thereof presented herein are provided with systems and methods for managing and/or triggering handovers of mobile access points, non-limiting examples of which are provided in U.S. Provisional Application Ser. No. 62/281,432, titled “Systems and Methods for Managing and Triggering Handovers of Mobile Access Points in a Network of Moving Things,” filed on Jan. 21, 2016, which is hereby incorporated herein by reference in its entirety.

Yet further, in accordance with various aspects of this disclosure, the networks and/or components thereof presented herein are provided with systems and methods for performing captive portal-related control and management, non-limiting examples of which are provided in U.S. Provisional Application Ser. No. 62/268,188, titled “Captive Portal-related Control and Management in a Network of Moving Things,” filed on Dec. 16, 2015, which is hereby incorporated herein by reference in its entirety.

Also, in accordance with various aspects of this disclosure, the networks and/or components thereof presented herein are provided with systems and methods for extrapolating high-value data, non-limiting examples of which are provided in U.S. Provisional Application Ser. No. 62/270,678, titled “Systems and Methods to Extrapolate High-Value Data from a Network of Moving Things,” filed on Dec. 22, 2015, which is hereby incorporated herein by reference in its entirety.

Additionally, in accordance with various aspects of this disclosure, the networks and/or components thereof presented herein are provided with systems and methods for providing remote software updating and distribution, non-limiting examples of which are provided in U.S. Provisional Application Ser. No. 62/272,750, titled “Systems and Methods for Remote Software Update and Distribution in a Network of Moving Things,” filed on Dec. 30, 2015, which is hereby incorporated herein by reference in its entirety.

Further, in accordance with various aspects of this disclosure, the networks and/or components thereof presented herein are provided with systems and methods for providing remote configuration updating and distribution, non-limiting examples of which are provided in U.S. Provisional Application Ser. No. 62/278,662, titled “Systems and Methods for Remote Configuration Update and Distribution in a Network of Moving Things,” filed on Jan. 14, 2016, which is hereby incorporated herein by reference in its entirety.

Still further, in accordance with various aspects of this disclosure, the networks and/or components thereof presented herein are provided with systems and methods for adapting the network, for example automatically, based on user feedback, non-limiting examples of which are provided in U.S. Provisional Application Ser. No. 62/286,243, titled “Systems and Methods for Adapting a Network of Moving Things Based on User Feedback,” filed on Jan. 22, 2016, which is hereby incorporated herein by reference in its entirety.

Yet further, in accordance with various aspects of this disclosure, the networks and/or components thereof presented herein are provided with systems and methods for enhancing and/or guaranteeing data integrity when building or performing data analytics, non-limiting examples of which are provided in U.S. Provisional Application Ser. No. 62/278,764, titled “Systems and Methods to Guarantee Data Integrity When Building Data Analytics in a Network of Moving Things,” Jan. 14, 2016, which is hereby incorporated herein by reference in its entirety.

Also, in accordance with various aspects of this disclosure, the networks and/or components thereof presented herein are provided with systems and methods for performing self-initialization and/or automated bootstrapping of mobile access points, non-limiting examples of which are provided in U.S. Provisional Application Ser. No. 62/286,515, titled “Systems and Methods for Self-Initialization and Automated Bootstrapping of Mobile Access Points in a Network of Moving Things,” filed on Jan. 25, 2016, which is hereby incorporated herein by reference in its entirety.

Additionally, in accordance with various aspects of this disclosure, the networks and/or components thereof presented herein are provided with systems and methods for managing power supply and/or utilization, non-limiting examples of which are provided in U.S. Provisional Application Ser. No. 62/295,602, titled “Systems and Methods for Power Management in a Network of Moving Things,” filed on Feb. 16, 2016, which is hereby incorporated herein by reference in its entirety.

Further, in accordance with various aspects of this disclosure, the networks and/or components thereof presented herein are provided with systems and methods for automating and easing the installation and setup of the infrastructure, non-limiting examples of which are provided in U.S. Provisional Application Ser. No. 62/299,269, titled “Systems and Methods for Automating and Easing the Installation and Setup of the Infrastructure Supporting a Network of Moving Things,” filed on Feb. 24, 2016, which is hereby incorporated herein by reference in its entirety.

In summary, various aspects of this disclosure provide communication network architectures, systems and methods for extrapolating high-value data from a network of moving things. As a non-limiting example, various aspects of this disclosure provide communication network architectures, systems, and methods for supporting a communication network comprising a complex array of both static and moving communication nodes (e.g., the Internet of moving things). While the foregoing has been described with reference to certain aspects and examples, it will be understood by those skilled in the art that various changes may be made and equivalents may be substituted without departing from the scope of the disclosure. In addition, many modifications may be made to adapt a particular situation or material to the teachings of the disclosure without departing from its scope. Therefore, it is intended that the disclosure not be limited to the particular example(s) disclosed, but that the disclosure will include all examples falling within the scope of the appended claims.

What is claimed is:

1. A method of optimizing performance of one or more third party wireless networks over a service area using a plurality of vehicles of a network of moving things, each vehicle comprising an on-board unit comprising a radio frequency interface supporting wireless communication with other vehicles of the plurality of vehicles, a global navigation satellite system (GNSS) receiver, a mobile access point for providing wireless access to end-user devices, and one or more radio frequency receivers, each radio frequency receiver of the one or more radio frequency receivers configurable to receive signals of a respective third party network of the one or more third party networks, the method comprising:
applying power to the on-board unit of a first vehicle to enable reception, by the corresponding one or more radio frequency receivers, of signals of the respective third party network;
collecting data representative of the signals of the one or more third party networks received by the corresponding one or more radio frequency receivers and corresponding geographic location information, during movement of the corresponding vehicle over the service area;
analyzing the collected data and the corresponding geographic location information to determine characteristics of wireless coverage of the one or more third party networks over the service area; and
transmitting new travel route information, to the on-board unit of the corresponding vehicle, for navigating movement of the corresponding vehicle over the service area according to the analysis of the collected data representative of the signals and the corresponding geographic location information.

2. The method according to claim 1, wherein the one or more third party networks comprise a wireless network that communicates using a cellular network radio interface protocol standard.

3. The method according to claim 1, wherein the one or more third party networks comprise a wireless network that communicates using a commercial broadcast radio frequency interface protocol standard.

4. The method according to claim 1, wherein the first vehicle is an autonomously navigated vehicle for operation on public roads.

5. The method according to claim 1, wherein applying power to the on-board unit of a first vehicle comprises provisioning the one or more radio frequency receivers to operate on the respective third party networks.

6. The method according to claim 1, wherein the method further comprises:
receiving, from an on-board unit of a second vehicle, data representative of the signals of the one or more third party networks and corresponding geographic location information collected by the second vehicle during movement of the second vehicle over the service area; and
analyzing the data collected at the first vehicle and the second vehicle and the corresponding geographic location information to determine characteristics of wireless coverage of the one or more third party networks over the service area.

7. The method according to claim 1, wherein the mobile access point provides end-user wireless Internet access to occupants of the first vehicle.

8. The method according to claim 1, wherein the data representative of the signals of the one or more third party networks is predictive of a quality of experience of end-users of the one or more third party networks.

9. The method according to claim 1, wherein the method further comprises:
transmitting results of the analysis for a particular third party network of the one or more third party networks to a cloud-based system, the cloud-based system generating one or more web pages representative of wireless service coverage of the particular third party network.

10. A non-transitory computer-readable medium having stored thereon, a computer program having at least one code section, the at least one code section being executable by one or more processors for causing the one or more processors to perform operations of a method for optimizing performance of one or more third party wireless networks over a service area using a plurality of vehicles of a network of moving things, each vehicle comprising an on-board unit comprising a radio frequency interface supporting wireless communication with other vehicles of the plurality of vehicles, a global navigation satellite system (GNSS) receiver, a mobile access point for providing wireless access to end-user devices, and one or more radio frequency receivers, each radio frequency receiver of the one or more radio frequency receivers configurable to receive signals of a respective third party network of the one or more third party networks, the method comprising, the steps of the method comprising:
applying power to the on-board unit of a first vehicle to enable reception, by the corresponding one or more radio frequency receivers, of signals of the respective third party network;
collecting data representative of the signals of the one or more third party networks received by the corresponding one or more radio frequency receivers and corresponding geographic location information, during movement of the corresponding vehicle over the service area;
analyzing the collected data and the corresponding geographic location information to determine characteristics of wireless coverage of the one or more third party networks over the service area; and
transmitting new travel route information, to the on-board unit of the corresponding vehicle, for navigating movement of the corresponding vehicle over the service area according to the analysis of the collected data representative of the signals and the corresponding geographic location information.

11. The non-transitory computer-readable medium according to claim 10, wherein the one or more third party networks comprise a wireless network that communicates using a cellular network radio interface protocol standard.

12. The non-transitory computer-readable medium according to claim 10, wherein the one or more third party networks comprise a wireless network that communicates using a commercial broadcast radio frequency interface protocol standard.

13. The non-transitory computer-readable medium according to claim 10, wherein the first vehicle is an autonomously navigated vehicle for operation on public roads.

14. The non-transitory computer-readable medium according to claim 10, wherein applying power to the on-board unit of a first vehicle comprises provisioning the one or more radio frequency receivers to operate on the respective third party networks.

15. The non-transitory computer-readable medium according to claim 10, wherein the method further comprises:
receiving, from an on-board unit of a second vehicle, data representative of the signals of the one or more third party networks and corresponding geographic location information collected by the second vehicle during movement of the second vehicle over the service area; and
analyzing the data collected at the first vehicle and the second vehicle and the corresponding geographic location information to determine characteristics of wireless coverage of the one or more third party networks over the service area.

16. The non-transitory computer-readable medium according to claim 10, wherein the mobile access point provides end-user wireless Internet access to occupants of the first vehicle.

17. The non-transitory computer-readable medium according to claim 10, wherein the data representative of the signals of the one or more third party networks is predictive of a quality of experience of end-users of the one or more third party networks.

18. The non-transitory computer-readable medium according to claim 10, wherein the method further comprises:
transmitting results of the analysis for a particular third party network of the one or more third party networks to a cloud-based system, the cloud-based system generating one or more web pages representative of wireless coverage of the particular third party network.

19. A system for optimizing performance of one or more third party wireless networks over a service area using a plurality of vehicles of a network of moving things, each vehicle comprising an on-board unit comprising:
a radio frequency interface supporting wireless communication with other vehicles of the plurality of vehicles;
a global navigation satellite system (GNSS) receiver;
a mobile access point for providing wireless access to end-user devices;
one or more radio frequency receivers, each radio frequency receiver of the one or more radio frequency receivers configurable to receive signals of a respective third party network of the one or more third party networks; and
one or more processors for communicatively coupling to the radio frequency interface, the GNSS receiver, the mobile access point, and the one or more processors, the one or more processors operable to, at least:
apply power to the on-board unit of a first vehicle to enable reception, by the corresponding one or more radio frequency receivers, of signals of the respective third party network;
collect data representative of the signals of the one or more third party networks received by the corresponding one or more radio frequency receivers and corresponding geographic location information, during movement of the corresponding vehicle over the service area;
analyze the collected data and the corresponding geographic location information to determine characteristics of wireless coverage of the one or more third party networks over the service area; and
transmit new travel route information, to the on-board unit of the corresponding vehicle, for navigating movement of the corresponding vehicle over the service area according to the analysis of the collected data representative of the signals and the corresponding geographic location information.

20. The system according to claim 19, wherein the one or more third party networks comprise a wireless network that communicates using a cellular network radio interface protocol standard.

21. The system according to claim 19, wherein the one or more third party networks comprise a wireless network that communicates using a commercial broadcast radio frequency interface protocol standard.

22. The system according to claim 19, wherein the first vehicle is an autonomously navigated vehicle for operation on public roads.

23. The system according to claim 19, wherein applying power to the on-board unit of a first vehicle comprises provisioning the one or more radio frequency receivers to operate on the respective third party networks.

24. The system according to claim 19, wherein the one or more processors are operable to, at least:
receive, from an on-board unit of a second vehicle, data representative of the signals of the one or more third party networks and corresponding geographic location information collected by the second vehicle during movement of the second vehicle over the service area; and
analyze the data collected at the first vehicle and the second vehicle and the corresponding geographic location information to determine characteristics of wireless coverage of the one or more third party networks over the service area.

25. The system according to claim 19, wherein the mobile access point provides end-user wireless Internet access to occupants of the first vehicle.

26. The system according to claim 19, wherein the data representative of the signals of the one or more third party networks is predictive of a quality of experience of end-users of the one or more third party networks.

27. The system according to claim 19, wherein the one or more processors are operable to, at least:
transmit results of the analysis for a particular third party network of the one or more third party networks to a cloud-based system, the cloud-based system generating one or more web pages representative of wireless coverage of the particular third party network.
